(19) United States
(12) Patent Application Publication
(10) Pub. No.: US 2005/0234797 A1
(43) Pub. Date: Oct. 20, 2005

(54) Principal retention options strategy computer support and method

(76) Inventor: Charles Schwartz, New Canaan, CT (US)

Correspondence Address: PETER K. TRZYNA, ESQ., P O BOX 7131, CHICAGO, IL, 60680, US

(21) Appl. No.: 11/107,630

(22) Filed: Apr. 15, 2005

Related U.S. Application Data
(60) Provisional application No. 60/562,860, filed on Apr. 16, 2004.

(51) Int. Cl. G06F 17/60

(52) U.S. Cl. 705/36

(57) ABSTRACT

Machine, method, and manufacturer pertaining to a computer-aided constructing of a principal-protected investment indexed to a reference portfolio. The method can include the steps of: entering into a computer a desired principal-protected amount, terms defining a reference portfolio call option indexed to performance of the reference portfolio, terms defining an index call option and an index put option indexed to an underlying that is not being substantially similar to the reference portfolio; and controlling the computer with a program to use the principal-protected amount and the terms to generate output including a combined cost of the three options substantially equal to the principal-protected amount, a combined expected payoff at expiration of the index call option and the index put option equal to the cost of the three options and a payoff at expiration of the reference portfolio call option substantially equal to increased value of the reference portfolio.

### I. PRIORITY

This application claims priority from, and incorporates by reference, U.S. Patent Application Ser. No. 60/562,860 titled “The Principal Retention Options (PRO) Strategy Computer Support And Method” filed 16 Apr. 2004, with same inventor applicant as listed herein.

### II. TECHNICAL FILED

The technical field is computers and data processing systems, as illustrated more particularly herein. Exemplary embodiments include, depending on the implementation, apparatus, a method for use and method for making, and corresponding products produced thereby, as well as data structures, computer-readable media tangibly embodying program instructions, manufactures, and necessary intermediates of the foregoing.

### Ill. BRIEF DESCRIPTION OF THE DRAWINGS

FIG. 1 shows a block diagram of a computer-aided methodology.

FIG. 2 shows a block diagram describing the construction of the Options and the Financing components.

FIG. 3 shows a spreadsheet defining certain risk characteristics of components of an Investment Portfolio proposed.

FIG. 4 shows a block diagram defining the execution of certain Tax Tests imposed on the Options.

FIG. 5 shows a spreadsheet that defines and executes the Tax Tests of an embodiment.

FIG. 6 shows a block diagram of the terms of the Options.

FIG. 7 shows a block diagram defining the calculation of the tax treatment of the Options.

FIG. 8 shows a block diagram of the terms of the Financing and the Collateral according to an embodiment.

FIG. 9 shows a block diagram defining the calculation of the tax treatment of the Financing.

FIG. 10 shows an electronic communication summarizing terms of an embodiment.

FIG. 11(A-B) shows a detailed term sheet of the Financing of an embodiment.

FIG. 12 shows a detailed term sheet of the Initial Cash Flows of an embodiment.

FIG. 13(A-E) shows a detailed term sheet of the Reference Portfolio Call Option of an embodiment.

FIG. 14(A-B) shows a detailed term sheet of the Index Call Option of an embodiment.

FIG. 15(A-B) shows a detailed term sheet of the Index Put Option of an embodiment.

FIG. 16 shows the structure of the opening of a leveraged principal-protected investment according to an embodiment.

FIG. 17 shows the structure of the termination of a leveraged principal-protected investment according to an embodiment.

FIG. 18 shows a spreadsheet that defines the inputs and summary results of a leveraged principal-protected investment according to an embodiment.

FIG. 19 shows a spreadsheet that calculates the results of a leveraged principal-protected investment according to an embodiment.

FIG. 20 shows the structure of the opening of a leveraged principal-protected investment to finance the purchase of life insurance according to an embodiment.

FIG. 21 shows the structure of the termination of a leveraged principal-protected investment to finance the purchase of life insurance according to an embodiment.

FIG. 22 shows a spreadsheet that defines the inputs and summary results of a leveraged principal-protected investment to finance the purchase of life insurance according to an embodiment.

FIG. 23 shows a spreadsheet that calculates the results of a leveraged principal-protected investment to finance the purchase of life insurance according to an embodiment.

FIG. 24 shows the structure of the opening of a leveraged principal-protected investment to finance the purchase and charitable contribution of life insurance according to an embodiment.

FIG. 25 shows the structure of the termination of a leveraged principal-protected investment to finance the purchase and charitable contribution of life insurance according to an embodiment.

FIG. 26 shows a spreadsheet that defines the inputs and summary results of a leveraged principal-protected investment to finance the purchase and charitable contribution of life insurance according to an embodiment.

FIG. 27 shows a spreadsheet that calculates the results of a leveraged principal-protected investment to finance the purchase and charitable contribution of life insurance according to an embodiment.

### IV. MODES

The detailed embodiments are disclosed herein; however, it is to be understood that the disclosed embodiments are merely illustrative of that which may be embodied-in various forms. Specific structural and functional details disclosed herein are not to be interpreted as limiting, but rather are representative or illustrative. Accordingly, the accompanying drawings for embodiments are intended to illustrate and exemplify in a teaching manner rather than limit the claims provided below.

Consider, for example, a leveraged exposure to an actively-managed investment fund, such as hedge funds. Investment portfolios, and hedge funds in particular, present a quandary for U.S. taxable investors. Hedge fund portfolios provide sophisticated investors with an opportunity to participate in portfolios managed by professional investment managers. Investments in individual hedge funds provide the opportunity for significant appreciation. However, these potential gains come with a variety of risks, including the risk of the full loss of investment, illiquidity, high volatility, and lack of transparency. The construction of a highly-diversified portfolio of hedge funds can address some or all such problems. A properly diversified hedge fund portfolio, such as a fund of hedge funds, can be designed to provide more conservative above-market returns with low volatility and low correlation to other traditional equity and fixed income asset classes.

Direct investments however in individual hedge funds or a diversified portfolio of hedge funds can generate inefficient tax implications for U.S. taxable investors. Because these actively-managed investment funds might be structured as partnerships for U.S. tax purposes, investors in the funds would be taxed each year on their allocable share of income and gain. A successful investment fund generates a large percentage of its profits from actively-traded positions giving rise to either ordinary income or short-term capital gains. Hedge funds might less frequently hold positions for longer than one year that give rise to long-term capital gains, which can be taxed at a preferential tax rate. As a consequence, because investment funds typically do not make periodic cash distributions to its investors, investors can be required to pay their current tax liabilities with out-of-pocket cash. Such things could be sometimes referred to as “phantom income,” namely the requirement to pay tax out-of-pocket without a distribution of the gains upon which such tax is calculated.

Investors can purchase financial instruments that protect against the risk of loss, namely principal-protected investments indexed to virtually any form of underlying. These investments can provide a contractual obligation to return the principal amount on the designated maturity date even in the case of loss of the underlying. If the underlying appreciates, however, the investor can receive a defined percentage of the underlying profits net of the implicit or explicit embedded cost of protection.

While principal-protected investments can be very attractive investments, their tax treatment for U.S. investors could, in certain situations, be inefficient. Principal-protected investments can be structured in a variety of different ways, but the following three alternatives are indicative of the problems faced by U.S. investors.

First, an investor could separately purchase a zero coupon bond for, say, $60 and a call option on the underlying for, say, $40. The zero coupon bond generates a $100 payment at maturity representing the guaranteed return of principal, while the option provides the upside potential of the underlying. In this case, the call option, properly structured, can be treated as an option and may give rise to a long-term capital gain at maturity. But the zero coupon bond gives rise to original issue discount, forcing the investor to recognize ordinary taxable income each year in a cumulative amount of $40.

Second, an investor could invest, say, $100 in a guaranteed investment fund, one that includes its underlying investments plus a guarantee, or option, from a third party guaranteeing the return of at least $100 at maturity. In this case, because the fund might be structured as a partnership, the investor must recognize its allocable share of income and gains each year even though the fund makes no cash distributions. In addition, assuming the fund increases in value over time, the guarantee within the fund is treated as an option and can give rise to a long-term capital loss.

Third, an investor could invest, say, $100 in a principal-protected note issued by a third party. In this case, the instrument is treated as a “contingent payment debt obligation” under section 1275 of the Internal Revenue Code. The principal-protected note is bifurcated into its two components: a zero coupon investment and an embedded derivative contract. The zero coupon investment could be deemed to be a bond costing $60 upfront and paying $100 at maturity and therefore subject to the original issue discount rules. Consequently, the investor would recognize ordinary taxable income each year in a cumulative amount of $40. The embedded derivative, a call option on the underlying, would be taxed on a mark-to-market basis and giving rise to ordinary income. Note that although the embedded derivative contract is deemed to be an option it is taxed not as an option but instead on a mark-to-market basis.

Therefore, while direct and principal-protected investments in actively-managed investment funds are an extremely important niche in the investment universe, their inefficient tax treatment actually prevents many U.S. investors from participation.

An alternative approach for a more tax-efficient investment in hedge funds is the introduction of leverage. A call option, properly structured, can give an investor a leveraged exposure to an underlying portfolio of hedge funds, for example, while generating a tax liability that is deferred and treated as a long-term capital gain if held for longer than one year. Two aspects to this approach are (1) the investor's risk appetite and (2) the tax integrity of the construction of the option contract.

A call option can be deemed an option for U.S. tax purposes if it is leveraged, namely if its upfront cost is a reasonable percentage of its notional amount. If such a call option costs, say, $25 for a notional amount of $100, the investor is essentially leveraging its exposure by fourfold but can limit the potential loss to $25. While this type of exposure may be very attractive for many investors, others may find the level of risk excessive and inappropriate.

In order for the call option to be treated as an option for U.S. tax purposes, of course the call option must qualify as an option according to the Internal Revenue Code. Most options are on highly liquid and transparent underlying assets such as stocks or bonds. But options on hedge funds or a portfolio of as many as 100 different hedge funds create a wide variety of hedging concerns and constraints. As a result, in order to address their hedging constraints, institutions that offer options on hedge fund portfolios typically include features and characteristics that make their options very “un-option” like.

While some options on investment portfolios can be structured conservatively and properly, some can contain features that contribute excessive risk that the instrument will instead be deemed a “constructive ownership transaction” under section 1260 of the Internal Revenue Code. The following features might be found in traditional hedge fund options that increase the risk that the financial instrument that is being issued will not be treated as an option for U.S. tax purposes:
A strike price that is excessively in-the-money, or substantially below the initial value of the underlying investment.
Any instrument that provides the investor with substantially all of the upside potential and substantially all of the downside risk.
A return of the premium cost, or other features that make the option act more like a “debt security.”
No reasonable possibility that the option will expire worthless.
An unreasonable and unrealistic upfront premium cost, such as one that include no “time value.”
Unilateral termination rights by the seller of the option at the liquidation value of the underlying, frequently called “barrier knock-out” features.
Option payouts that include explicit or implicit calculations of interest costs incurred by the seller in hedging the option.
Non-formulaic features that allow the seller or buyer of the option to adjust the terms of the option, such as re-leveraging and additional premium payments.

However, by not including some or preferably all of the above features, a transaction can be structured that is a substantially more conservative investment for U.S. taxpayers. An embodiment herein includes a borrowing can substantially replicate the pre-tax cash flows of a properly-structured option contract. Such embodiments also can produce a more tax-efficient investment vehicle for both non-leveraged and leveraged investments.

Consider some definitional aspects first. As used herein, the term “computer” generally refers to hardware or hardware in combination with one or more program(s), such as can be implemented in software. Computer aspects can be implemented on general purpose computers or specialized devices, and can operate electrically, optically, or in any other fashion. A computer as used herein can be viewed as at least one computer having all functionality or as multiple computers with functionality separated to collectively cooperate to bring about the functionality. Logic flow can represent signal processing, such as digital data processing, communication, or as evident from the context hereinafter. Logic flow can be implemented in discrete circuits. Computer-readable media, as used herein can comprise at least one of a RAM, a ROM, A disk, an ASIC, and a PROM. Industrial applicability is clear from the description, and is also stated below.

In the context of a structured transaction system discussed herein, aspects can extend to facilitating operation of an electrical communication system, and an enabling machine, as well as an article of manufacture (e.g., documentation output) also products produced by the process such as documentation, and necessary intermediates such as data, communications, etc. Thus, computer support and aspects thereof are arranged and configured to carry out one or more aspects of the transactions, (e.g., documentation, tracking, valuation, tax handling, accounting, etc.) coordinated to accomplish financial aspects as could not be accomplished as efficiently without this approach, having technical utility therein.

The computer support can handle inputting data as discussed subsequently, analyzing the data to determine the best approach and/or rights and/or benefits or responsibilities associated therewith, etc., generating documentation, producing illustrations and reports, contracts, accounting and accounting results, consolidated data, etc. Preferably there are computer systems for access, as aided by human steps facilitating the entire computer-assisted system, along with transmission systems and receiver systems. In view of the complexity of the transactions associated with this innovation, it may be best to establish standardization, especially with data standards. Thus, an embodiment contemplates data standards carried out from data templates and generally standardized documentation (with customization as may be desired for individual transactions).

Indeed, computer support can reach to many related activities, including optimizing, product fulfillment, underwriting, optimizing pay outs, communications with all involved parties, tracking, billing and transfers (including electronic funds transfers), protected communications by encryption, records management, real time and batch processing utilizing distributed networks and Internet protocol communications, product definition and determinations related thereto, as well as budgeting, reporting, and analysis, all by computer-aided means.

In accordance therewith, there is an apparatus (computer system(s)), methods of making and using the apparatus, and products (documentation and other output) as well as necessary intermediates (e.g., data, documents, electronic communications, etc.), as discussed more with regard to the Figures. Such illustration shows the nature of the transaction that gives rise to need for the computer system, standardized data specifications, template input, and other aspects discussed herein.

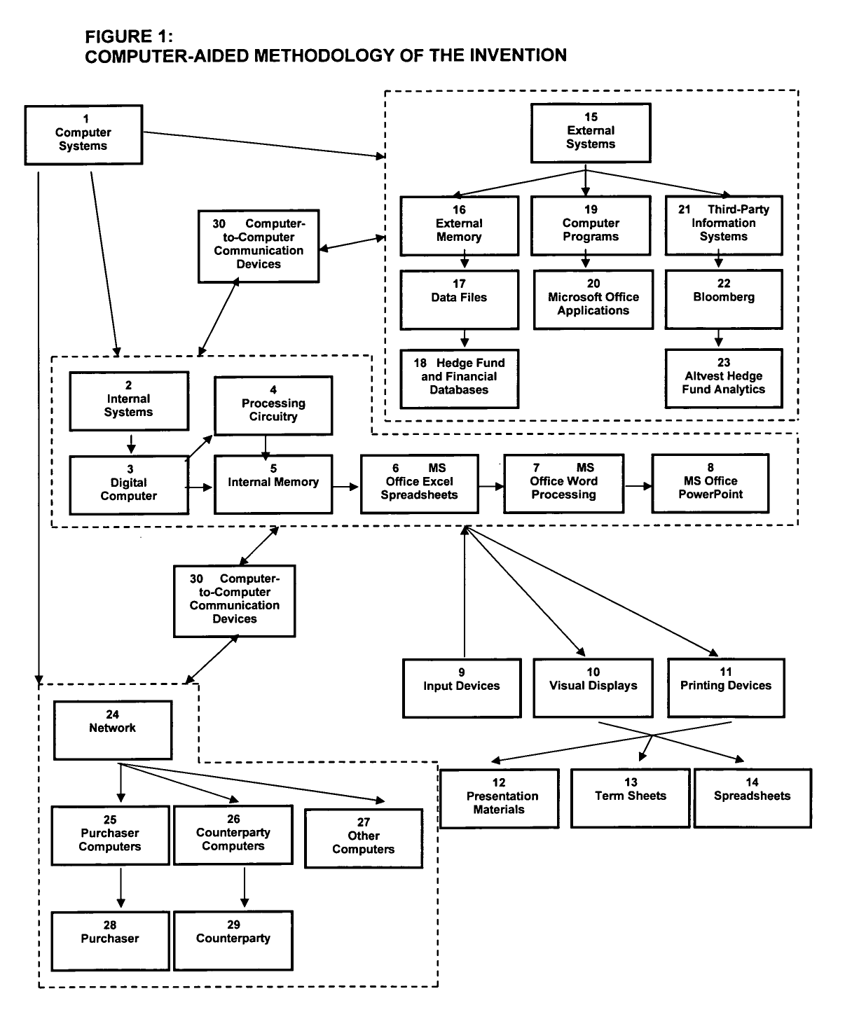

Now then, by way of the following prophetic teaching, there is provided computer support, as in a data processing system, for implementing all or some parts of a tax-efficient principal-protected investment indexed to a customized Investment Portfolio. Turn now to FIG. 1, where there is illustrated a computer-aided methodology. The principal-protected investment can be composed of at least three purchased Options 86 and, in an embodiment, a zero coupon loan. This computer-aided methodology relies upon the processing and communication amongst Computer Systems 1 in order to arrange and execute a transaction between the Purchaser 28 and Counterparty 29.

The Computer Systems 1 can have Internal Systems 2, which communicate with both External Systems 15 and Network 24. Internal Systems 2 can include a Digital Computer 3 and its related peripheries. For example, the Digital Computer 3 can be electronically and/or wirelessly connected to a variety of peripheries such as Input Devices 9, e.g., a wireless keyboard, a keyboard attached to an additional laptop computer, and a keyboard attached to the Bloomberg 22 system, etc. There can be four Visual Displays 10: the Digital Computer 3 display monitor, the laptop computer monitor, twin Bloomberg 22 display monitors, and a television connected to a video conferencing unit.

The Digital Computer 3 is arranged and configured to process raw data collected from the External Systems 15 and the Network 24 and transform it using one program or a variety of software. This computer-aided methodology facilitates communication, such as constant multi-directional communication, between the Internal Systems 2 and both the External Systems 15 and the Network 24.

For example, interplay may begin with a communication from a potential Purchaser 28 who communicates an inquiry from its Purchaser Computer(s) 25 to the Digital Computer 3 through Computer-to-Computer Communication Device(s) 30. These communication devices may include, for example, a digital modem connected to the Digital Computer 3 and the laptop computer to facilitate e-mail and/or transmission of information, and an Internet connection, a digital modem attached to a video conferencing unit, a digital modem attached to the Bloomberg 22, and a fax machine, and so forth. The Purchaser 28's inquiry typically leads to creation of a transaction proposal in one or more embodiments herein.

A transaction proposal may require a significant amount of raw data, which is acquired through Computer-to-Computer Communication Devices 30 from External Systems 15. The Digital Computer 3 accesses the Data Files 17 of various External Memory 16 databases, e.g., through its Internet connection. For example, in order to construct an acceptable Investment Portfolio 65, one can download historical risk and return statistics of certain investment funds. Through the Internet, the Digital Computer 3 can access and download information from a variety of Hedge Fund and Financial Databases 18, such as investorforce.com, hedgefund.net, and hedgefundresearch.com. The Digital Computer 3 can access other Third-Party Information Systems 21 for both additional data and for financial and investment portfolio analytics. For example, Bloomberg 22 can be used as a source for financial data and analytics such as swap rates, LIBOR interest rates, and forward LIBOR interest rates. This information can be used for the pricing and simulation of various components of the Options 86 and the Financing 73, if any. The Digital Computer 3 can access one or more websites that provide investment and hedge fund portfolio analytics, such as the Altvest Hedge Fund Analytics 23 at investorforce.com. The Digital Computer 3 can communicate with Other Computers 27 of the Network 24, such as computers of various investment and hedge funds to determine corresponding interest in potentially being included in the selected Investment Portfolio 65.

The Digital Computer 3 can download such data from the External Systems 15 through the Computer-to-Computer Communication Devices 30 and stores the data in its Internal Memory 5. Data and files can be secured on the Digital Computer 3's internal hard drive as well as on an external hard drive. The Digital Computer 3 hard drive can contain an array of Spreadsheets 14 arranged to price, analyze, simulate, and/or test different embodiments as may be desired in various applications. The hard drive of Digital Computer 3 can contain various applications that aide in performing functions, for example, MS Office Excel Spreadsheets 6, MS Office Word Processing 7, and MS Office Powerpoint 8. The calculation power of the Spreadsheets 14 is supported by the Processing Circuitry 4 of Digital Computer 3. Because the computer-aided methodology can use MS Office Excel Spreadsheets 6, the software and applications generating them can be frequently or easily updated. The Digital Computer 3 updates its software and applications by accessing Computer Programs 19, particularly Microsoft Office Applications 20, through Computer-to-Computer Communication Devices 30.

The Digital Computer 3 deploys its collected data and analytical applications to indicatively price and structure in accordance herewith. For example, in order to confirm terms of the transaction, the Digital Computer 3 can communicate through Computer-to-Computer Communication Device(s) 30 to the Counterparty Computer(s) 26 of a potential Counterparty 29 for the transaction. At least one Counterparty 29 communicates back to the Digital Computer 3 to confirm terms and pricing of the transaction.

Once confirmed, the Digital Computer 3 can generate a set of Presentation Materials 12, Term Sheets 13, and Spreadsheets 14, e.g., to be transmitted to the Purchaser 28. These materials can be created/displayed on the Visual Displays 10 and may either be printed on one of the Printing Devices 11 and faxed or transmitted electronically to the Purchaser 28 through Computer-to-Computer Communication Devices 30. Of course that which is transmitted has a corresponding receiver to obtain the transmitted information, as illustrated herein.

Through such multi-directional communications, a principal-protected investment proposal ultimately evolves (e.g., stepwise incrementing to completion) and is then approved by both the Purchaser 28 and the Counterparty 29. Once terms and pricing have been agreed to by the Purchaser 28 and Counterparty 29, the Digital Computer 3 transmits a signal to confirm execution to both Purchaser Computers 25 and Counterparty Computers 26.

Following such execution, the Digital Computer 3 can use its MS Office Excel Spreadsheets 6 to monitor the transaction for the Purchaser 28. The Counterparty Computer(s) 26 can, e.g., periodically, communicate financial updates and mark-to-market valuations of the Options 86 and the Financing 73, if any, to the Digital Computer 3. The Digital Computer 3, in turn, can communicate this information in a revised format using MS Office Excel Spreadsheets 6 and MS Office Word Processing 7 to the Purchaser Computers 25.

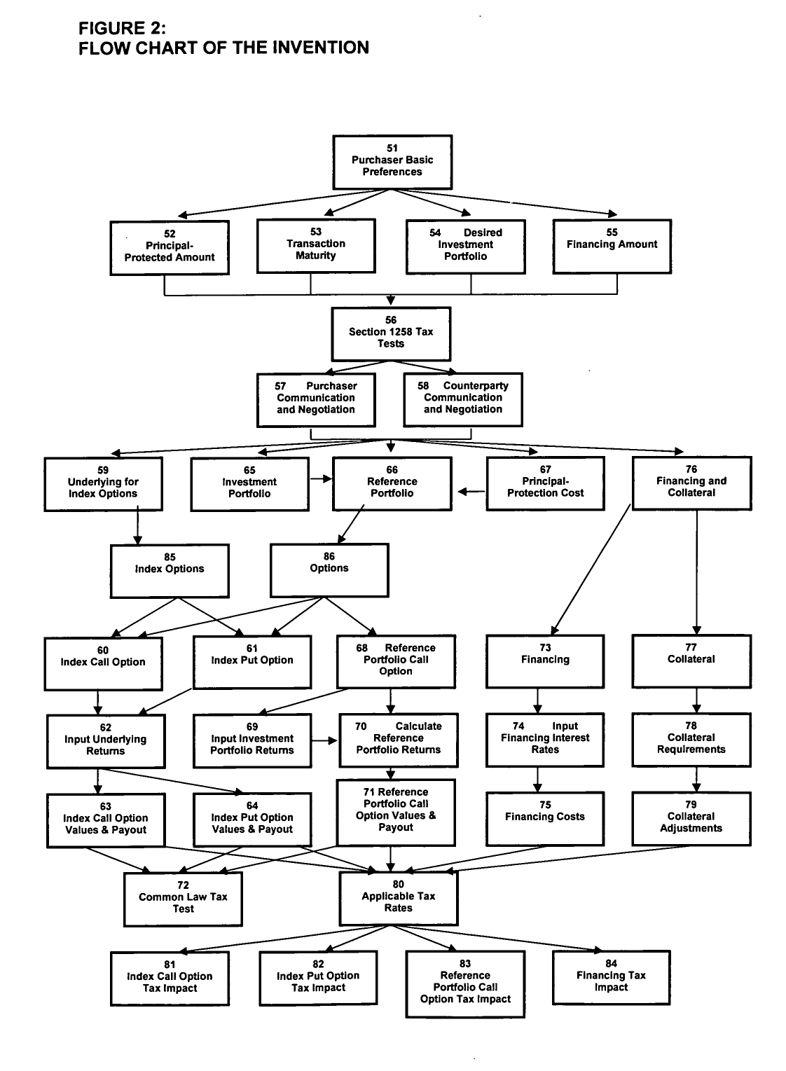

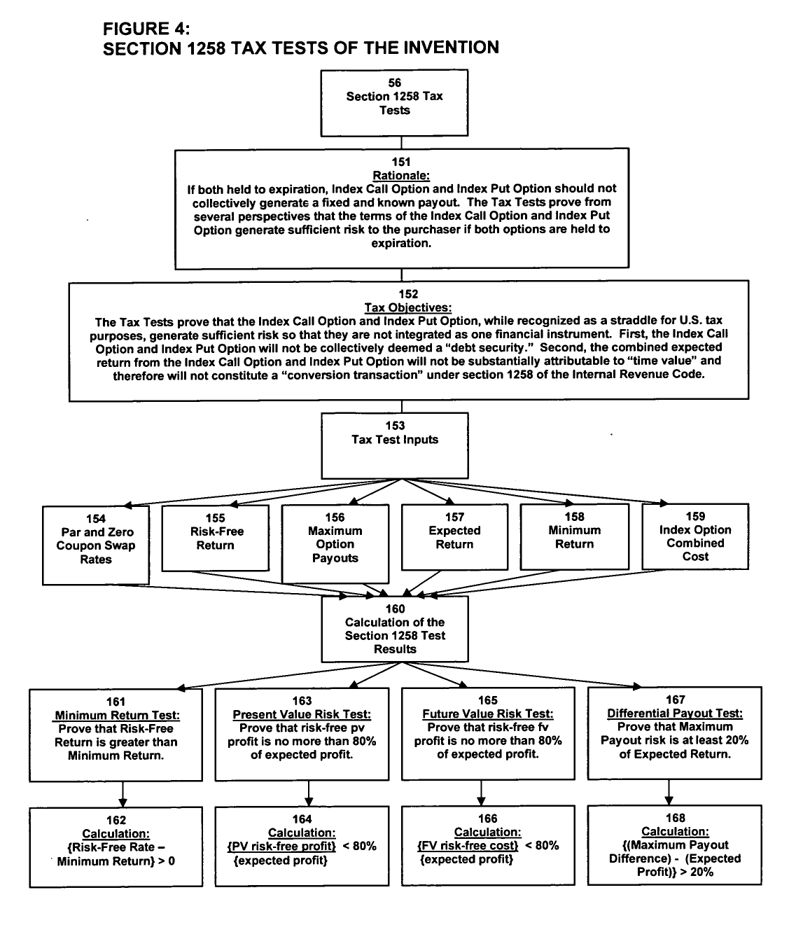

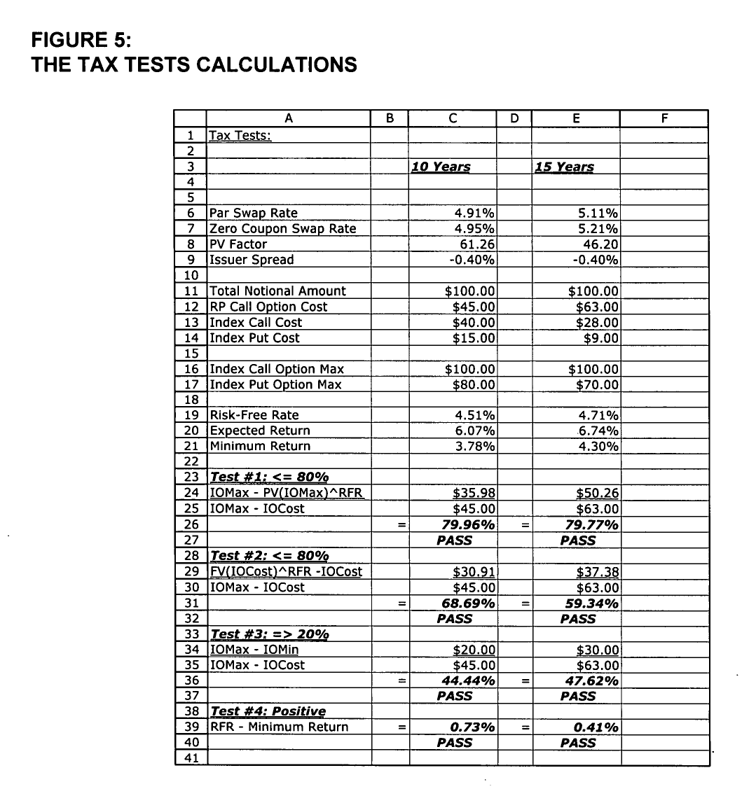

Turn now to FIG. 2, a representative flow chart. The construction of different embodiments of the principal-protected investment depends upon definition of Purchaser Basic Preferences 51. The Purchaser 28 defines, preferably in an interactive process, one or several components, such as the Principal-Protected Amount 52, the Transaction Maturity 53, the Desired Investment Portfolio 54, and the Financing Amount 55. Once the Purchaser Basic Preferences 51 are defined, the Digital Computer 3 in FIG. 1 can perform the Section 1258 Tax Tests 56, which are exemplified in FIG. 4 and FIG. 5. Results of the Section 1258 Tax Tests 56 define constraints on the construction of the Options 86 that form the principal-protected investment. The basic terms are finalized, e.g., as a result of both the Purchaser Communication and Negotiations 57 and at least one potential Counterparty Communication and Negotiations 58.

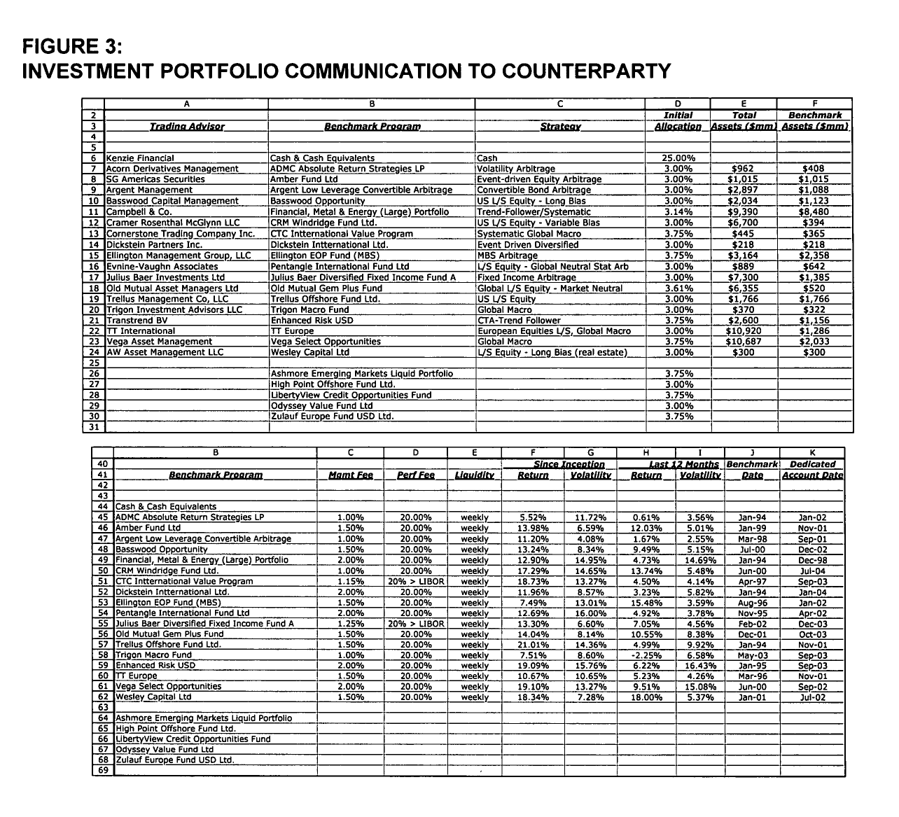

Depending on the application desired, an initial objective of these negotiations might be to determine an underlying for the Options 86 that can comprise the embodiment of the principal-protected investment. The principal-protected investment can be indirectly indexed to performance of a particular Investment Portfolio 65. The Investment Portfolio 65 can be a highly-diversified investment or hedge fund portfolio, e.g., that would be approved by the Counterparty 29. The investment funds contained in the Investment Portfolio 65 have certain risk characteristics. These characteristics can include, for example, adequate assets under management, frequent liquidity and redemption rights, acceptable volatility, and a proven track record of adequate net investment performance. The Counterparty Communication and Negotiation 58 can include communication(s) describing the components of a proposed Investment Portfolio 65. Investment Portfolio Spreadsheet 101 and Investment Portfolio Spreadsheet 102 in FIG. 3 display many of the important variables that influence acceptability of an investment or hedge fund portfolio.

Indexation to the Investment Portfolio 65 can be indirect rather than direct, e.g., to reduce both financial risk and tax risk. The principal-protected investment can be indexed instead to a Reference Portfolio 66, a notional portfolio typically composed of both the Investment Portfolio 65 and a cash portfolio. The Reference Portfolio 66 may be defined by a dynamic allocation to the Investment Portfolio 65 and the cash portfolio based upon a formulaic allocation process. The notional and formulaic characteristics of the Reference Portfolio 66 can be such as to ensure that the Options 86 forming the principal-protected investment pass the Common Law Tax Test 72. The Common Law Tax Test 72 addresses the requirement that the Purchaser 28 not be treated as the owner for tax purposes of the Investment Portfolio 65 under common law.

Once the Counterparty 29 approves the Reference Portfolio 66, one can define the Principal-Protection Cost 67, which can be an annual expense that reduces the notional value of the Reference Portfolio 66. The Principal-Protection Cost 67 can represent compensation to Counterparty 29 for its risk of protecting the Principal-Protected Amount 52 on the Transaction Maturity 53 in the case that the selected Investment Portfolio 65 declines over time.

The Purchaser 28 can also select the Underlying for Index Options 59, where such underlying can be any asset or index that is not substantially offsetting to the value of the Reference Portfolio 66. Purchaser 28 can select an Underlying for Index Options 59 on the basis of an expectation that such underlying will generally increase in value over the course of the Transaction Maturity 53. Consequently, the Underlying for Index Options 59 can display historical returns that have been positive in a non-volatile manner.

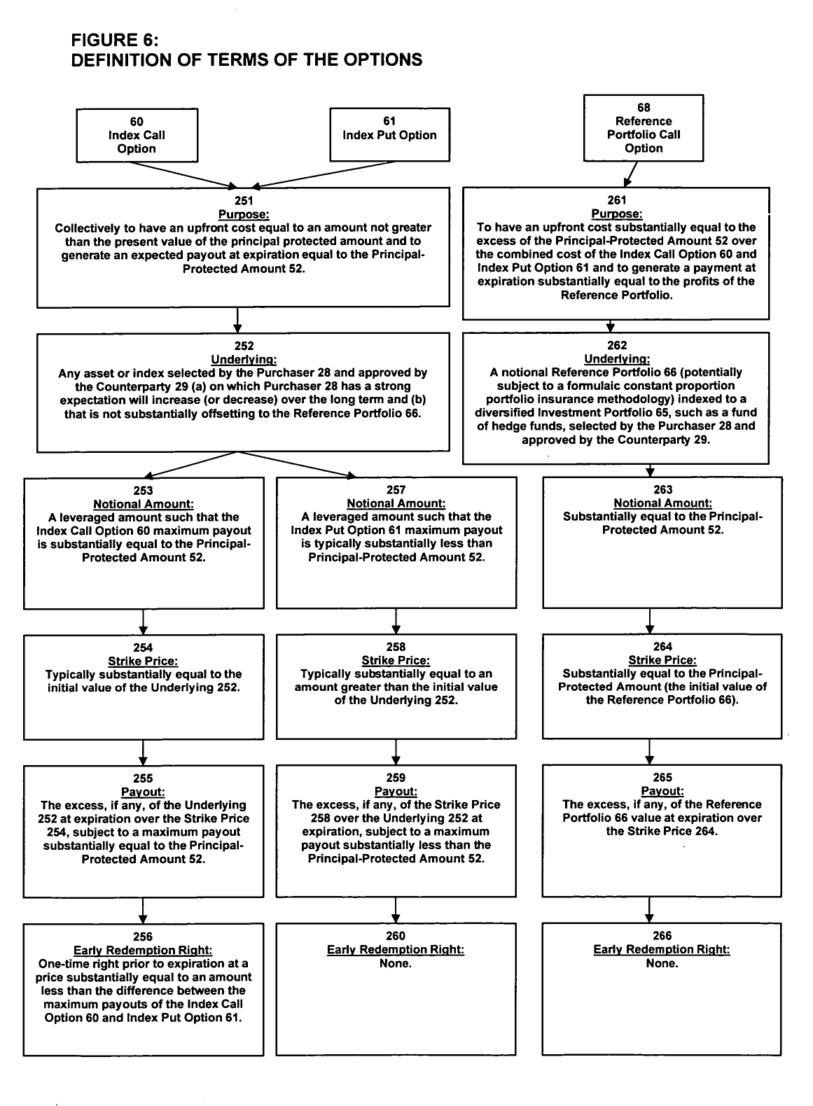

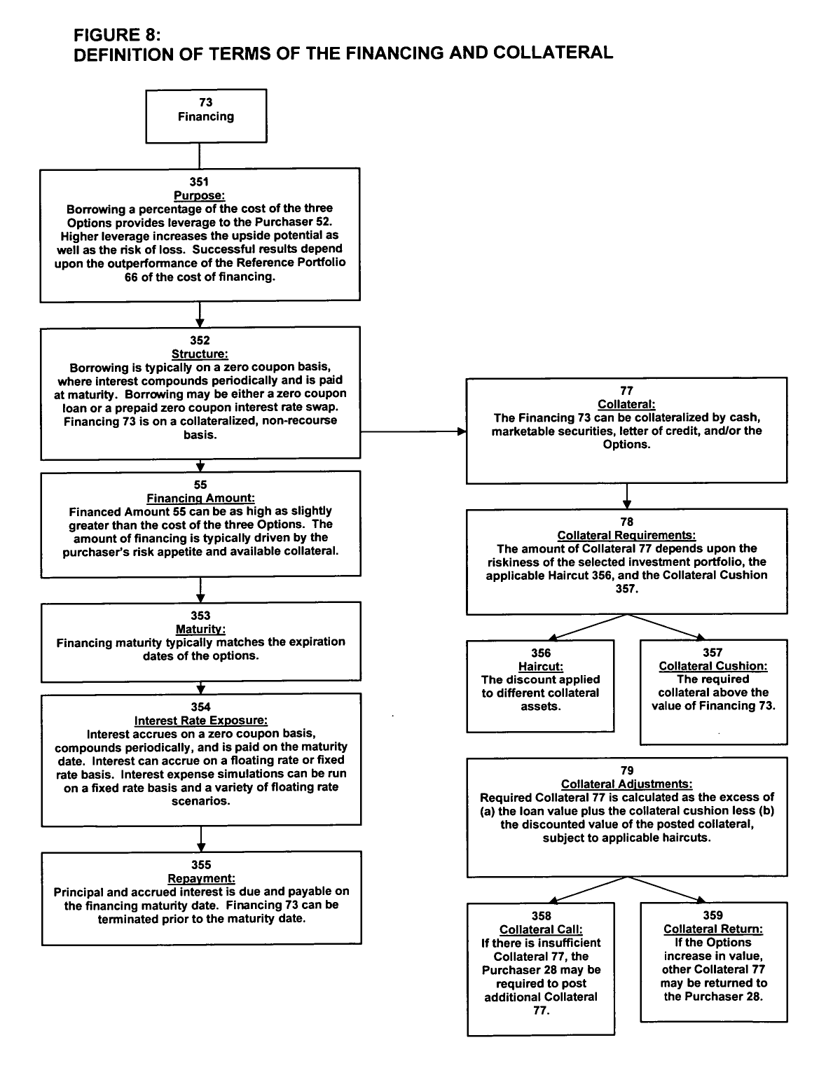

Further computer-aided communications (transmission/reception; real time, and/or interactive, as may be desired throughout embodiments herein) amongst the Digital Computer 3, the Purchaser 28, and the Counterparty 29 lead to definition of the terms of the Index Call Option 60, Index Put Option 61, and Reference Portfolio Call Option 68, all three of which can collectively be referred to as the Options 86. The Digital Computer 3 can specify terms of the Options 86. The Index Call Option 60 and Index Put Option 61 are collectively referred to as the Index Options 85. If a selected embodiment includes Financing and Collateral 76, then the terms of the Financing 73 and Collateral 77 can also be defined. The terms of the Options 86 are exemplified in detail in FIG. 6. The terms of the Financing 73 and Collateral 77 are exemplified in detail in FIG. 8.

To either simulate or monitor performance, one can input periodic returns of the underlyings of each of the Options 86 as well as costs of borrowing. As investment returns and borrowing costs are communicated to Digital Computer 3, Spreadsheets 14 can be used to Input Underlying Returns 62, Input Investment Portfolio Returns 69, Calculate Reference Portfolio Returns 70, Input Financing Interest Rates 74, and calculate Collateral Requirements 78.

Using these inputs to obtain results, the Spreadsheets 14 can calculate the current values and payout of each of the Options 86. The Input Underlying Returns 62 permits the calculation of the Index Call Option Values and Payout 63 and the Index Put Option Values and Payout 64. The Calculate Reference Portfolio Returns 70 permits the calculation of the Reference Portfolio Call Option Values and Payout 71. The Calculate Financing Interest Rates 74 permits the calculation of the Financing Costs 75. And finally, the Collateral Requirements 78 permit the calculation of Collateral Adjustments 79.

Given the values and payouts of the Index Call Option 60, Index Put Option 61, Reference Portfolio Call Option 68, and Financing 73, the Spreadsheets 14 can calculate the tax impact of each of these components. First, the Applicable Tax Rates 80 can be input into the Spreadsheets 14. Then the Spreadsheets 14 can calculate the Index Call Option Tax Impact 81, Index Put Option Tax Impact 82, Reference Portfolio Call Option Tax Impact 83, and Financing Tax Impact 84. Based upon the particular tax treatment and character of each of the components, the Spreadsheets 14 can calculate in detail both the amount of tax liability or deduction for each of the components as well as their net after-tax impact.

Turn now to FIGS. 4 and 5 for an illustrative teaching of representative section 1258 tax tests and tax test calculations. Depending on the situation at issue, an objective of the Index Options 85 can be to generate an expected outcome at expiration substantially equal to the Principal-Protected Amount 52 from a U.S. tax perspective. While the Purchaser 28 may expect that outcome to be highly likely, it could be viewed as inappropriate to structure the Index Options 85 so that such outcome is a virtual certainty. If that were the case, then there is a risk from a U.S. tax perspective that the Index Options 85 might be integrated into one transaction and be treated as a “debt security.” The Rationale 151 of the Section 1258 Tax Tests 56 is therefore to prove that the terms of the Index Call Option 60 and Index Put Option 61 generate sufficient risk to the Purchaser 28.

Tax Objectives 152 of the tests are such as to prove that the combination of the Index Call Option 60 and Index Put Option 61 are not deemed to be a “debt security” nor a “conversion transaction” under section 1258 of the Internal Revenue Code.

The Tax Test Inputs 153 can include the following: (a) Par and Zero Coupon Swap Rates 154 to determine the benchmark interest rate; (b) the Risk-Free Return 155 as the borrowing rate of the Counterparty 29; (c) the Maximum Option Payouts 156 to determine the range of combined payouts at expiration; (d) the Expected Return 157 resulting from a maximum payout of the Index Call Option 60; (e) the Minimum Return 158 resulting from a maximum payout of the Index Put Option 61; and (f) the Index Option Combined Cost 159. These inputs allow for the Calculation of the Section 1258 Tax Tests 160. Each of these calculations is depicted in the Spreadsheet 201 in FIG. 5.

The Minimum Return Test 161, defined as Test #4 in cell A38 of Spreadsheet 201, proves that the Risk-Free Return 155 is greater than a return generated by a payout at expiration equal to the maximum payout of the Index Put Option 61. Its Calculation 162 defines the difference between the two investment returns. The results of these calculations are displayed in cell C39 for a 10-year maturity and E39 for a 15-year maturity in Spreadsheet 201.

The Present Value Risk Test 163, defined as Test #1 in cell A23 of Spreadsheet 201, proves that the present value of the profit generated by the Risk-Free Return 155 is not more than 80% of the profit from the Expected Return 157. Its Calculation 164 compares the expected profit to the present value of the profit from the Expected Return 157. The results of these calculations are displayed in cell C26 for a 10-year maturity and E26 for a 15-year maturity in Spreadsheet 201.

The Future Value Risk Test 165, defined as Test #2 in cell A28 of Spreadsheet 201, proves that the future value of the combined cost of the Index Options 85 calculated at the Risk-Free Return 155 is not more than 80% of the profit from the Expected Return 157. Its Calculation 166 compares the expected profit to the future value of the combined cost of the Index Options 85 calculated at the Risk-Free Return 155. The results of these calculations are displayed in cell C31 for a 10-year maturity and E31 for a 15-year maturity in Spreadsheet 201.

The Differential Payout Test 167, defined as Test #3 in cell A33 of Spreadsheet 201, proves that the difference between the Maximum Option Payouts 156 is no less than 20% of the profit from the Expected Return 157. Its Calculation 168 compares the difference between the maximum payouts of the Index Call Option 60 and Index Put Option 61 to the profit from the Expected Return 157. The results of these calculations are displayed in cell C36 for a 10-year maturity and E36 for a 15-year maturity in Spreadsheet 201.

Turn now to FIG. 6 for illustrative definitions of terms of the options. In one embodiment, in order to create a tax-efficient principal-protected investment, there can be a replicating of cash flows of a principal-protected investment, generating a tax liability that is deferred until the redemption date, and converting the character of the gain to a capital gain. In another embodiment that includes leverage, there can be a replicating of the cash flows of a principal-protected investment, generating a tax liability that is deferred until the redemption date, converting the character of the gain to a capital gain, and giving rise to the availability of interest expense deductions.

On a pre-tax basis, the cash flows from the Options 86 can be designed to generate a combined upfront cost substantially equal to that of a principal-protected investment and combined payouts at maturity substantially equal to the redemption amount of a principal-protected investment. The purpose of the Index Options 85 is to generate a payout at maturity substantially equal to the Principal-Protected Amount 52. In addition, the combined upfront cost of the Index Options 85 eliminates the need for the Counterparty 29 to borrow funds in order to execute a hedge of the Reference Portfolio Call Option 68.

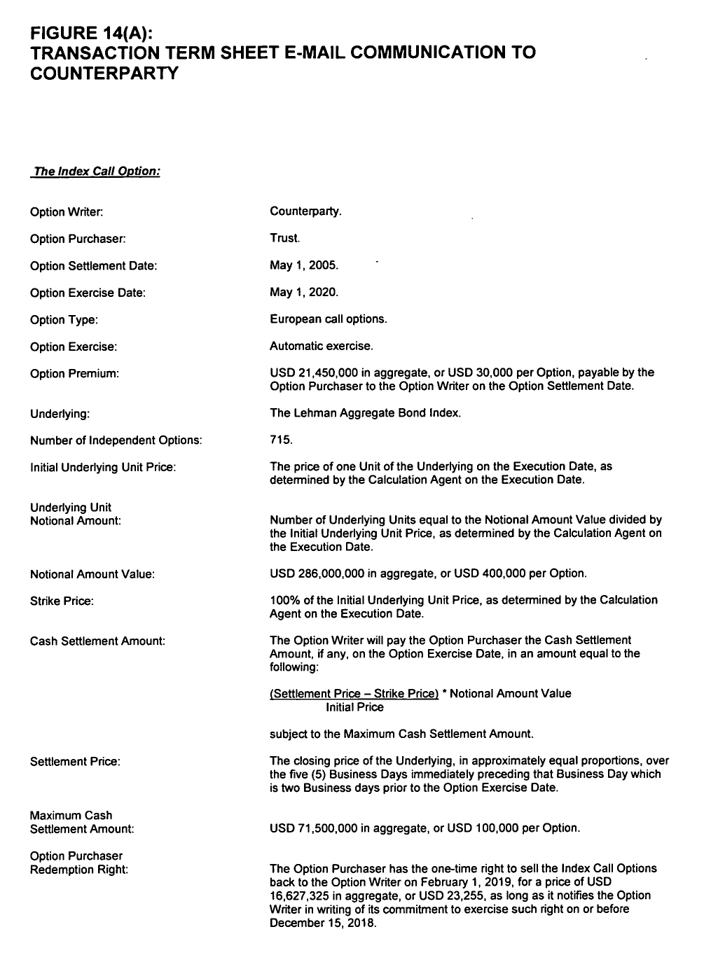

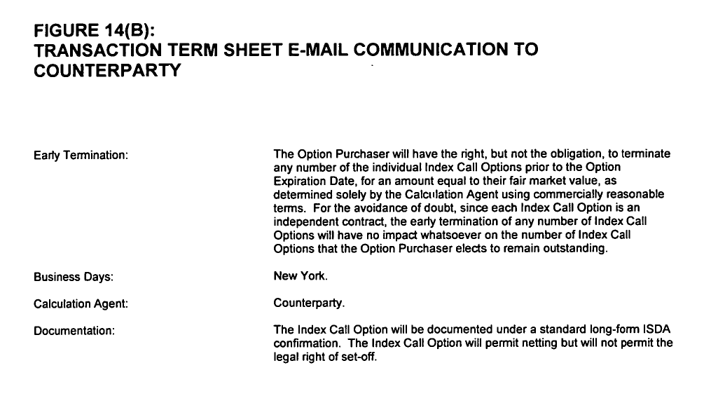

The Notional Amount 253 of the Index Call Option 60 Underlying 252 can be calculated as an amount such that its maximum payout is substantially equal to the Principal-Protected Amount 52. The Strike Price 254 is typically substantially equal to the initial value of the Underlying 252. The Payout 255 of the Index Call Option 60 can be defined as the excess, if any, of the value of the Underlying 252 at expiration over the Strike Price 254, subject to the maximum payout of the Index Call Option 60. The Index Call Option 60 can contain an Early Redemption Right 256, whereby the Purchaser 28 has the one-time right to sell the Index Call Option 60 back to the Counterparty 29 on a defined date prior to the scheduled exercise date. Although the Purchaser 28 may have the expectation that the Index Call Option 60 will pay its maximum payout at expiration, the Index Call Option 60 has some chance on its issuance date of expiring worthless. A detailed term sheet of the Index Call Option 60 structured in one embodiment is exemplified in Term Sheet 531 in FIG. 14(A) and Term Sheet 532 in FIG. 14(B). Note that some or all of this data may be involved.

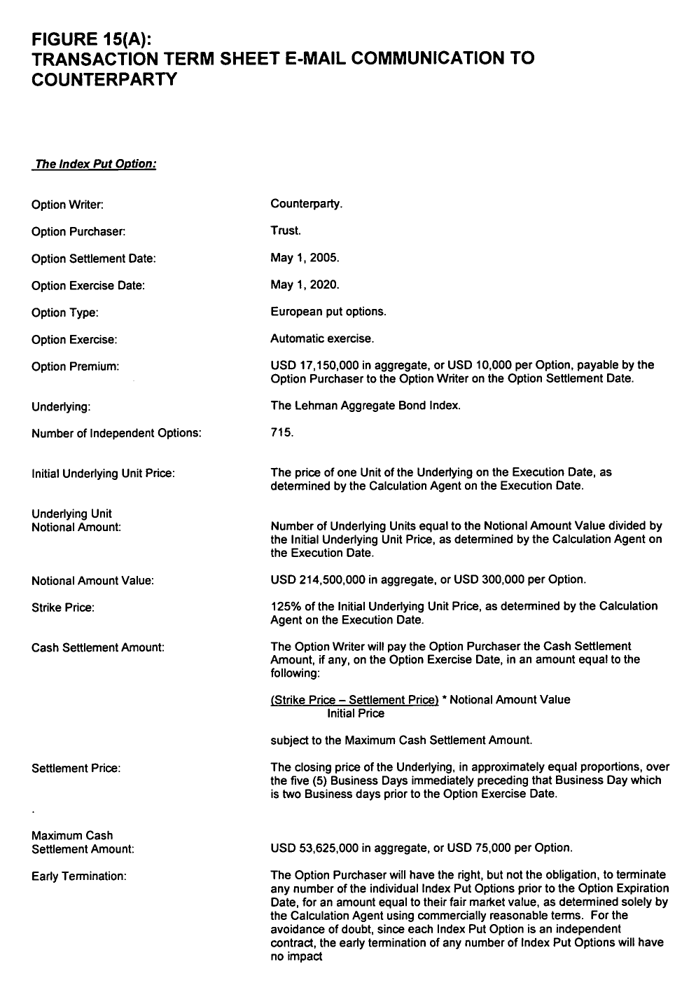

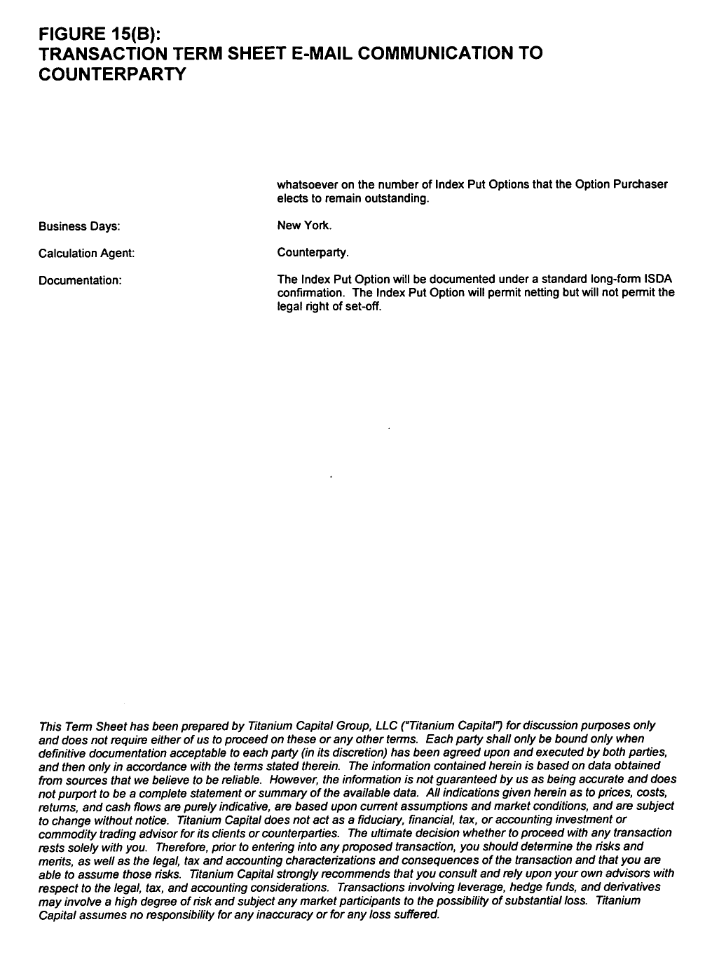

The Notional Amount 257 of the Index Put Option 61 Underlying 252 can be calculated as an amount such that its maximum payout is substantially less than the Principal-Protected Amount 52. Typically the maximum payout of the Index Call Option 60 can be greater than the maximum payout of the Index Put Option 61. However, in other embodiments, the maximum payout of the Index Call Option 60 can be less than the maximum payout of the Index Put Option 61. The Strike Price 258 can be greater than the initial value of the Underlying 252. The Payout 259 of the Index Put Option 61 can be defined as the excess, if any, of the Strike Price 258 over the value of the Underlying 252 at expiration, subject to the maximum payout of the Index Put Option 61. The Index Put Option 61 might not contain an Early Redemption Right 260. Although the Purchaser 28 may have the expectation that the Index Put Option 61 will expire worthless at expiration, the Index Put Option 61 has some chance on its issuance date of not expiring worthless. A detailed term sheet of the Index Put Option 61 structured in one embodiment is exemplified in Term Sheet 541 in FIG. 15(A) and Term Sheet 542 in FIG. 15(B). Note that some or all of this data may be involved.

The Purpose 261 of the Reference Portfolio Call Option 68 can be to generate a payout at expiration substantially equal to the increased value, or profits, of the Reference Portfolio 66. The Underlying 262 of the Reference Portfolio Call Option 68 can be the Reference Portfolio 66, a notional portfolio that can be dynamically and formulaically indexed to the Investment Portfolio 65 and a cash portfolio. However, in other embodiments the Reference Portfolio 66 can be defined as virtually any notionally-indexed investment. The Notional Amount 263 of the Reference Portfolio Call Option 68 Underlying 262 can be defined as an amount substantially equal to the initial value of the Reference Portfolio 66, also substantially equal to the Principal-Protected Amount 52. The Strike Price 264 can be substantially equal to the initial value of the Underlying 262. In one embodiment, the Strike Price 264 can be equal to the initial value of the Reference Portfolio 66. The Strike Price 264, however, preferably should not be an amount substantially, for example 25%-30%, less than the initial value of the Reference Portfolio 66.

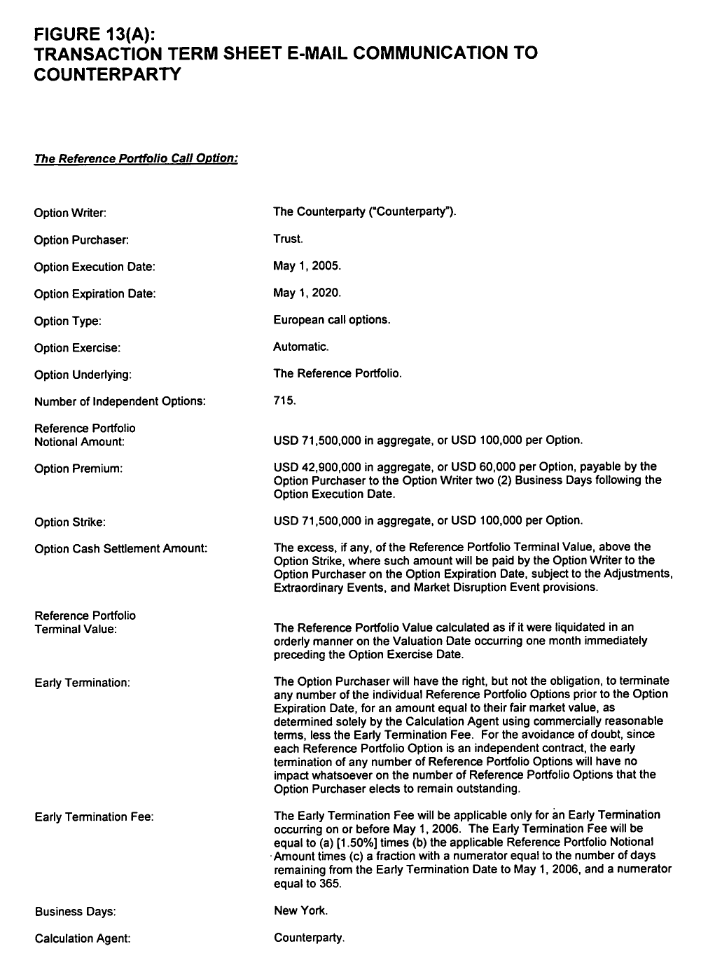

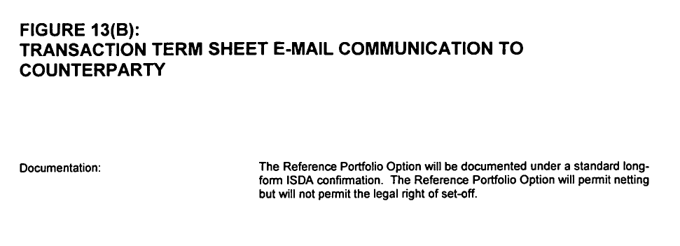

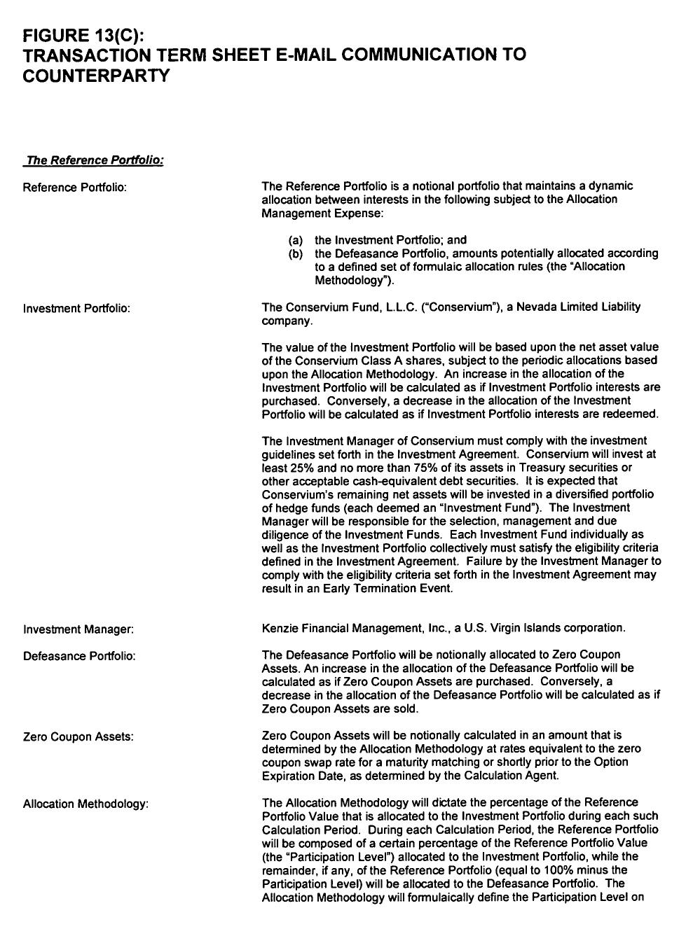

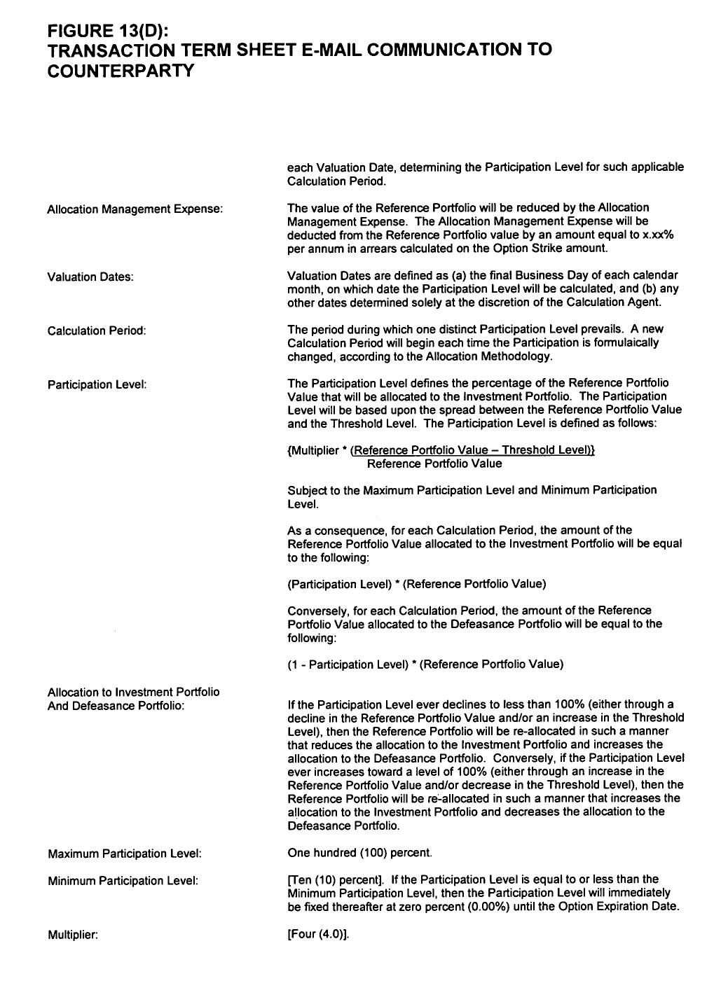

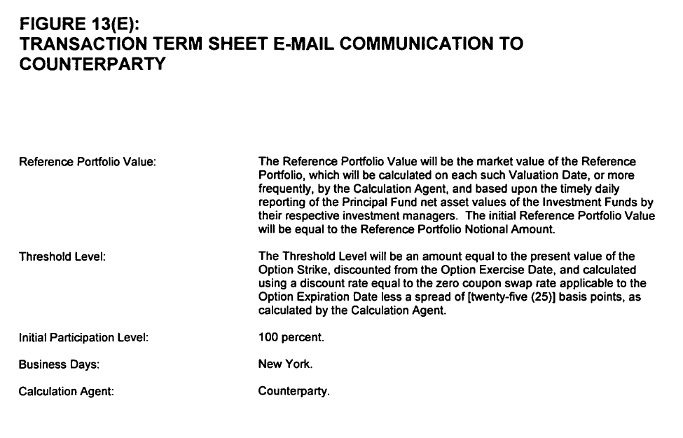

The Payout 265 of the Reference Portfolio Call Option 60 can be defined as the excess, if any, of the value of the Underlying 262 at expiration over the Strike Price 264. Because the upfront cost of the Index Options 85 can finance the hedge of the Reference Portfolio Call Option 68, the Payout can include no reference whatsoever to interest costs. The inclusion of interest costs in the payout of an option increases risk either that such option may be deemed a “constructive ownership transaction” or that the owner of such option may be deemed the owner of the underlying assets for U.S. tax purposes under common law. Although the Purchaser 28 again may have the expectation that the Reference Portfolio Call Option 68 will generate a Payout 265 at expiration, the Reference Portfolio Call Option 68 has some chance on its issuance date of expiring worthless. A detailed term sheet of the Reference Portfolio Call Option 68 structured in one embodiment is exemplified in Term Sheet 521 in FIG. 13(A), Term Sheet 522 in FIG. 13(B), Term Sheet 523 in FIG. 13(C), Term Sheet 524 in FIG. 13(D), and Term Sheet 525 in FIG. 13(E). Note that some or all of this data may be involved.

Each of the Options 86 can be priced, documented, and executed independently. Moreover, the Purchaser 28 can have the right to sell back any one or more of the Options 86 to the Counterparty 29 at a mutually-agreed price prior to the expiration date.

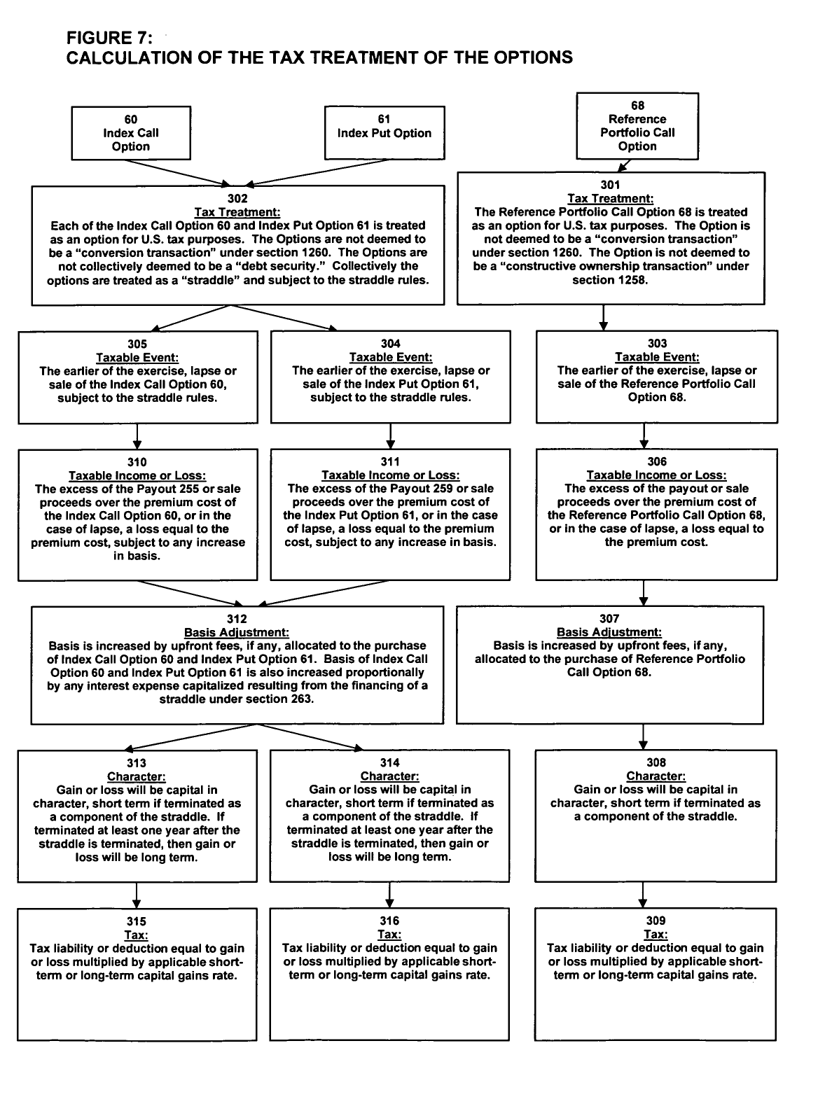

Turn now to FIG.7 for an illustrative teaching of calculating tax treatment of the options. The Tax Treatment 301 of the Reference Portfolio Call Option 68 and the Tax Treatment 302 of the Index Call Option 60 and Index Put Option 61 can be that the Index Options 85 are treated as options for U.S. tax purposes. The Index Options 85 independently or collectively should not be deemed to be “conversion transactions” under section 1258 of the Internal Revenue Code. The Index Options 85 independently or collectively should also not be deemed to be any of the enumerated transactions classified as “constructive ownership transactions” under section 1260 of the Internal Revenue Code. Collectively, the Index Call Option 60 and Index Put Option 61 are treated as a “straddle” and subject to the straddle rules. Note that the present discussion is directed to current tax law, but it is intended that the ideas advanced herein are to be viewed consistent with applicable tax law as it may evolve too.

The Taxable Event 303 of the Reference Portfolio Call Option 68 can be deferred until the earlier of its exercise, lapse, or sale. Taxable Income or Loss 306 arising from the Reference Portfolio Call Option 68 is equal to the excess of its Payout 265, if any, over its initial premium cost, or in the case of lapse, a loss equal to the premium cost. The Basis Adjustment 307 increases the basis of the Reference Portfolio Call Option 68 by the portion of any upfront fees allocated to its purchase. The Character 308 of Taxable Income or Loss 306 is capital, long term if the holding period exceeds one year. If the Reference Portfolio Call Option 68 gives rise to a gain, the Tax 309 liability will be equal to the taxable income multiplied by the applicable long-term capital gains rate.

The Taxable Event 305 of the Index Call Option 60 and Taxable Event 304 of the Index Put Option 61 can be deferred until the earlier of each Index Option 85's exercise, lapse, or sale. Taxable Income or Loss 310 arising from the Index Call Option 60 and Taxable Income or Loss 311 arising from the Index Put Option 61 can be equal to the excess of Payout 255 and Payout 259 respectively, if any, over each Index Option 85's respective initial premium cost. In the case of lapse, loss can be equal to the respective premium cost. The Basis Adjustment 312 of the Index Options 85 increases the basis of each Index Option 85 by that portion of any upfront fees allocated to each Index Option 85's purchase. The Basis Adjustment 312 also increases the basis of the Index Call Option 60 and Index Put Option 61 if a Financing 73 is used to leverage the purchase of the Options 86. Section 263 of the Internal Revenue Code limits the current deductibility of interest expense from borrowings used to finance the purchase of a straddle. Because the Index Call Option 60 and Index Put Option 61 collectively form a straddle, interest expense allocated to the purchase of the Index Options 85 can be capitalized and used to increase the basis of the Index Options 85 on a pro rata basis. Consequently, embodiments that include Financing 73 reduce taxable income resulting from the Index Call Option 60 and Index Put Option 61.

The Character 313 of Taxable Income or Loss 310 and the Character 314 of Taxable Income or Loss 311 can be capital. Subject to the straddle rules, as long as the Index Options 85 form a straddle, then any capital gain or loss resulting from the Index Call Option 60 or Index Put Option 61 can be a short-term gain or loss. Either the Index Call Option 60 or Index Put Option 61 can give rise to a long-term capital gain or loss if such Index Option 85 is exercised, sold, or lapses at least one year following the termination of the other Index Option 85 forming the straddle. If in one embodiment the Index Call Option 60 gives rise to a gain and the Index Put Option 61 gives rise to a loss, then the Tax 315 liability can be equal to the taxable income multiplied by the applicable short-term capital gains rate and the Tax 316 deduction can be equal to the taxable loss multiplied by the applicable short-term capital gains rate. The net tax result can be a net short-term capital gain. If the embodiment includes Financing 73, it is not unreasonable that the Index Options 85 forming the straddle can give rise to either a negligible tax event or a net short-term capital loss.

Turn now to FIG. 8 for an illustrative definition of terms of a sample financing with collateral. In an embodiment that includes a Financing 73 to leverage the purchase of the principal-protected investment, borrowing all or a portion of the purchase price of the Options 86 can increase the risk of the transaction, as well as influence both the upside potential and downside risk. The Purpose 351 of the borrowing can be to increase returns if the Reference Portfolio 66 outperforms the cost of borrowing.

The Maturity 353 of the Financing 73 can match the expiration dates of the Options 86. The Structure 352 of the Financing 73 can be a zero coupon loan, which can be structured as a loan or a prepaid zero coupon interest rate swap. Under a prepaid zero coupon interest rate swap, a lender pays an upfront amount to the Purchaser 28 in exchange for the obligation by the Purchaser 28 to pay the lender the upfront amount plus an accumulated interest amount on the maturity date. The accumulated interest amount can depend upon the spread over LIBOR charged by the lender. If the Options 86 are pledged as the core Collateral 73 to the lender then the resulting loan spread to LIBOR can be reduced to low levels. The Purchaser 28 can manage Interest Rate Exposure 354 by electing to have interest accrue on either a fixed or floating rate basis. Loan Repayment 355 occurs at Maturity, but the Purchaser 73 can elect to repay the loan prior to Maturity without penalty. The lender may either be a third-party institution or the same Counterparty 29 that sells the Options 86 to the Purchaser 28.

The Financing Amount 55 can range from zero to an amount greater than the purchase price of the Options 86. Because the Financing 73 can be arranged as a collateralized non-recourse loan, larger loans can require a larger amount of Collateral 77. The Purchaser 28 has the flexibility to pledge a variety of different assets as Collateral 77, but in one embodiment, the majority of the Collateral 77 can be the Options 86.

The Collateral Requirements 78 determine the amount of Collateral 77 to be pledged to secure the Financing 73. Because the borrowing is non-recourse, the lending institution can only be permitted to secure repayment of all obligations from the Collateral 77. The lending institution may not be permitted to have recourse directly to the Purchaser 28. A consequence of this form of non-recourse borrowing can be that the Purchaser 28's maximum exposure at any point can be the amount of pledged Collateral 77. All pledged assets are subject to a Haircut 356 that discounts the collateral value of the asset based upon the asset's particular liquidity and riskiness. For example, U.S. Treasuries carry a Haircut 356 of 0% while certain hedge fund interests carry a Haircut 356 of 25%. Assets discounted by the Haircut 356 can be pledged in an amount sufficient to equal more than 100% of the accrued value of the Financing 73. This excess collateral requirement, the Collateral Cushion 357, can be designed to provide a cushion before Collateral Adjustments 79 are made.

The loan can be structured as a margin variation loan. If the Reference Portfolio 66—and thus the value of the Options 86—underperforms the accrued cost of the loan, then the lender can issue a Collateral Call 358. Conversely, if the Reference Portfolio 66—and thus the value of the Options 86—outperforms the accrued cost of the loan, then the lender may be capable of effecting a Collateral Return 359.

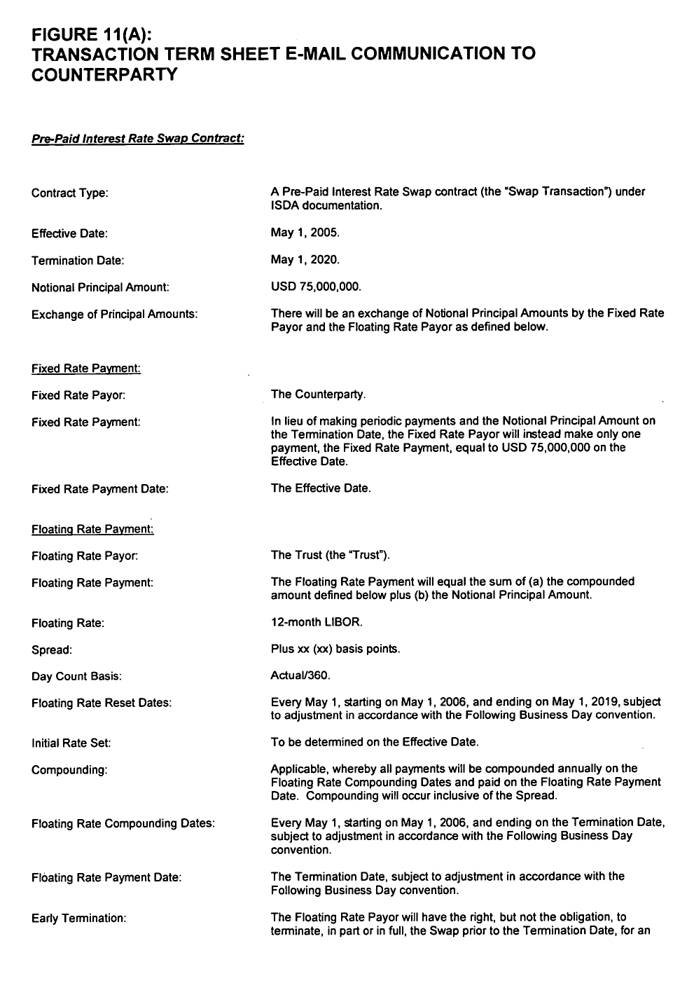

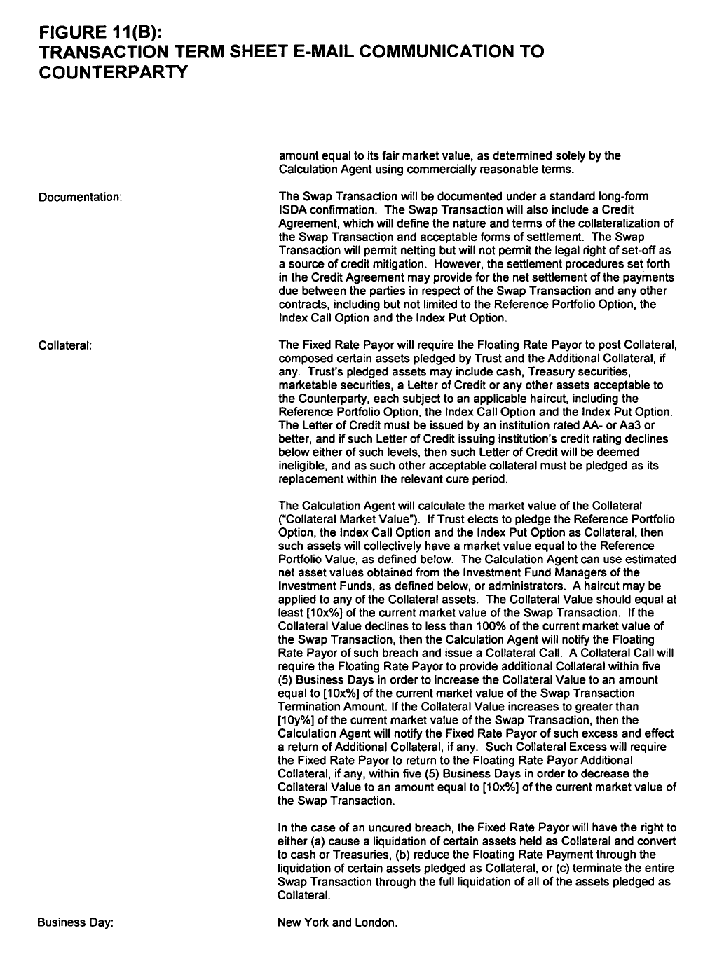

A representative term sheet of the Financing 73 structured in one embodiment is exemplified in Term Sheet 501 in FIG. 11(A) and Term Sheet 502 in FIG. 11(B). Note that some or all of this data may be involved.

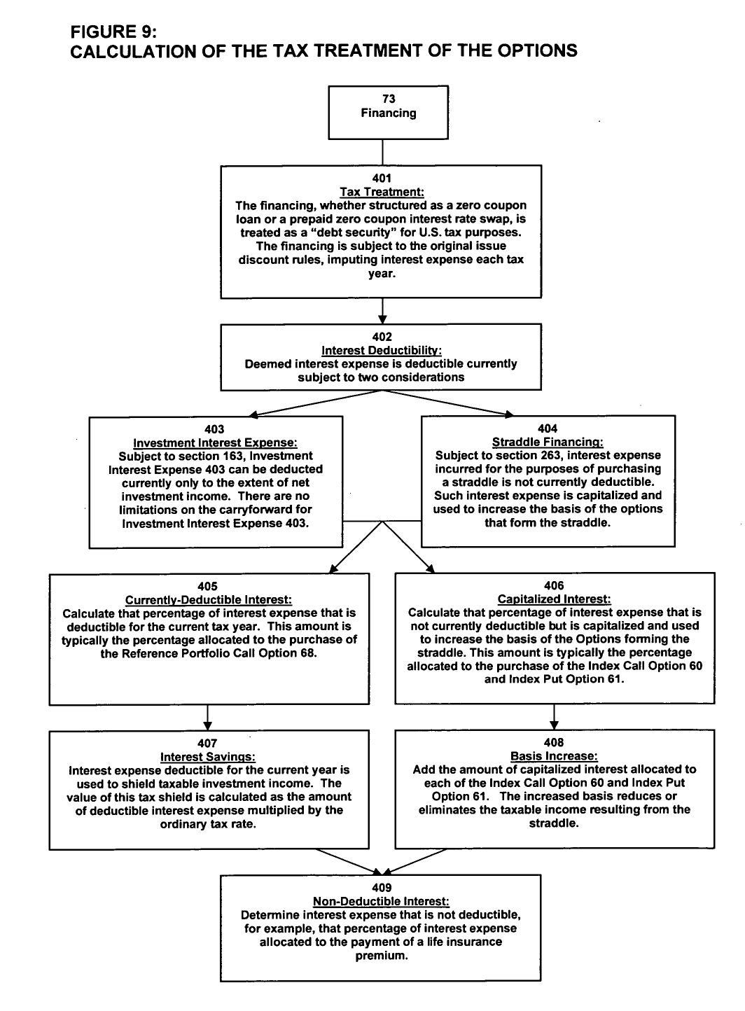

Turning now to FIG. 9, there is an illustration of a calculation of tax treatment of the financing. Because the Financing 73 can be structured as a zero coupon borrowing, the Purchaser 28 pays no interest currently; interest on an accumulated basis can be instead paid at maturity. However, the Tax Treatment 401 of the Financing 73 can treat the zero coupon loan or prepaid zero coupon interest rate swap as a “debt security.” The “debt security” can be subject to the original issue discount rules under the Internal Revenue Code, whereby deductible interest expense can be imputed each tax year. The Interest Deductibility 402 of the Financing 73 however can be subject to at least two considerations.

First, where the loan is used to finance an investment, as can be the case to varying degrees under one embodiment or another, interest expense can be deemed Investment Interest Expense 403. Investment Interest Expense 403 can be currently deductible up to the amount of the taxpayer's net investment income for such year under section 163 of the Internal Revenue Code. Investment Interest Expense 403 that is not deductible during a tax year can be carried forward to future years without limit. In addition, the taxpayer can elect to use Investment Interest Expense 403 to offset long-term capital gains.

Second, Straddle Financing 404 limits the deductibility of interest. If Financing 73 is used fully or partially to finance the purchase of positions that qualify as a straddle, then that portion of the interest expense allocated to the purchase of the straddle is not currently deductible. Instead, such interest expense can be Capitalized Interest 406 and used to increase the basis of the positions forming the straddle. In one embodiment, interest expense allocable to the purchase of the Index Call Option 60 and Index Put Option 61 can be capitalized and used to increase the basis of the Index Options 85. In an embodiment that deploys fully-leveraged borrowing, the resulting Basis Increase 408 can reduce or eliminate any taxable income resulting from the Index Call Option 60 and Index Put Option 61.

Currently-Deductible Interest 405 is interest expense that can be allocated to the purchase of the Reference Portfolio Call Option 68. This deductible interest acts as a tax shield against fully-taxable investment income. Interest Savings 406 for each tax year can be therefore calculated as the amount of Currently-Deductible Interest 405 multiplied by the applicable ordinary tax rate.

Certain interest expense may however be Non-Deductible Interest 409. For example, in an embodiment that can involve borrowing used to finance the purchase of the Options 86 and a life insurance policy, interest expense that is allocable to the payment of an insurance premium is not deductible.

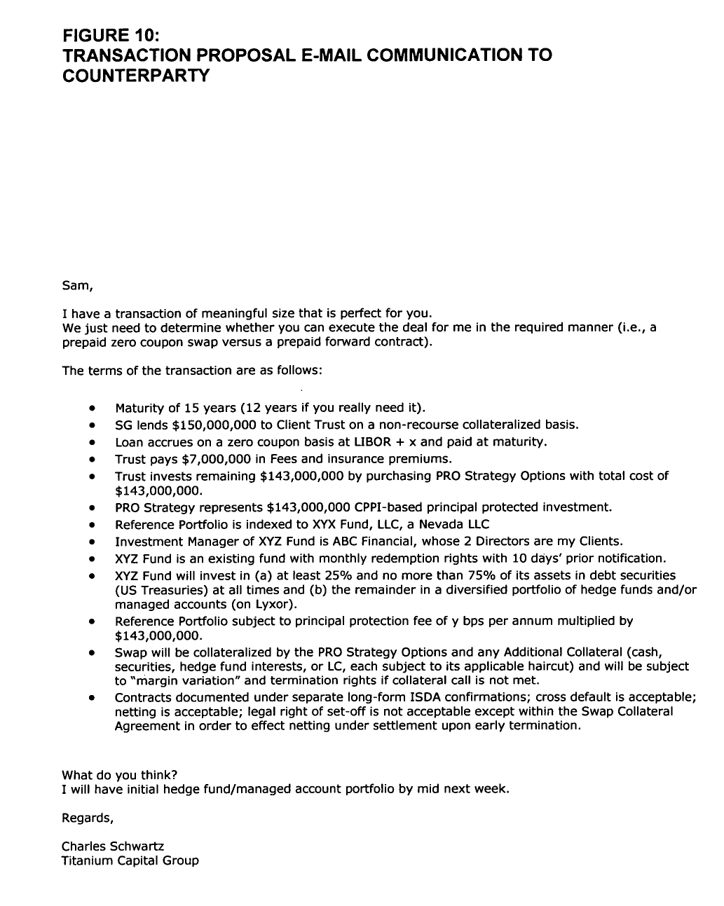

Now turn to FIG. 10 for an illustration of a representative transaction communication transmitted to, and received by, a counterparty. For example, in what could be a constant interaction and negotiation with the Purchaser 28 and the Counterparty 29, once the Purchaser Basic Preferences 51 have been identified, the parties can communicate electronically in order to define and negotiate the terms of the transaction.

To enable interaction and negotiation with the Purchaser 28 and the Counterparty 29, embodiments may use systems to transmit and receive communications. These systems at a basic level might be an email system, but other means for transmitting and receiving data consistent with the context herein will also suffice. For efficiency sake, reference is made herein as “Email”.

E-Mail 451 in FIG. 10 represents a standard communication with a Counterparty 29 in order to solicit initial acceptance and pricing of an embodiment. Because the details have already been disclosed and explained to the Counterparty 29, this summary list should be sufficient for the Counterparty 29 to understand the proposed transaction. E-Mail 451 can identify, for example, several characteristics of the proposed transaction is used to finance the purchase of a life insurance policy.
The Transaction Maturity 53 is 15 years.
The Financing Amount 55 is $150,000,000.
The Purchaser 28 is paying $7,000,000 in insurance premiums and fees.
The Purchaser 28 uses the remaining $143,000,000 to purchase the Options 86 as a principal-protected investment.
The Principal-Protected Amount 52 is $143,000,000.
The Desired Investment Portfolio 54 is identified.
Collateral 77 guidelines.

Such are representative. Note that some or all of this data may be involved.

Now turn to FIGS. 11, 12, 13, 14, 15 for an equally representative transaction term sheet, wherein some or all of this data may be involved.

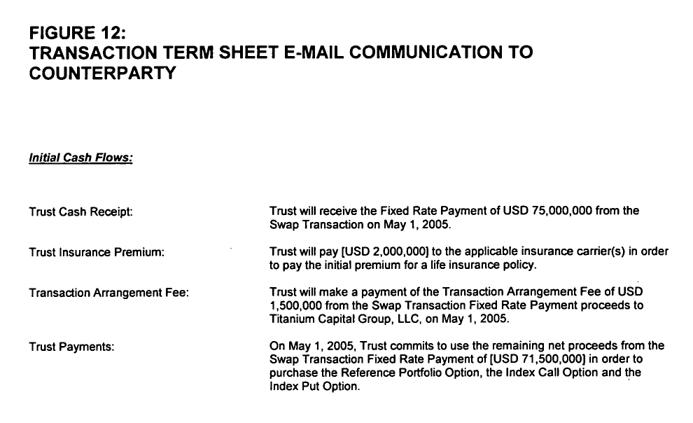

FIGS. 11, 12, 13, 14, and 15 show a term sheet of each of the components of an embodiment, by way of conceptional. The transaction described in this term sheet includes Financing 73 in the form of a prepaid zero coupon interest rate swap, as depicted in FIG. 11. The allocation of the proceeds of the Financing 73 is described in FIG. 12. Only a small percentage of the loan proceeds can be used to pay certain fees and pay the initial premium for a guaranteed no-lapse life insurance policy. The remainder of the proceeds can be used to purchase the Options 86. The terms of the Reference Portfolio Call Option 68 are described in FIG. 13. The terms of the Index Call Option 60 are described in FIG. 14. The terms of the Index Put Option 61 are described in FIG. 15.

Now consider borrowing outside of an individual's estate in order to acquire a fully paid-up life insurance policy with no out-of-pocket costs, as yet another embodiment. In order to fully pay-up the life insurance policy, an insurance premium can be made due at the maturity of the transaction. This “catch-up” insurance premium can be funded by the potential outperformance of the Reference Portfolio over the accrued cost of the loan. The success of the transaction will depend upon the magnitude of this outperformance, if any, over the duration of the transaction.

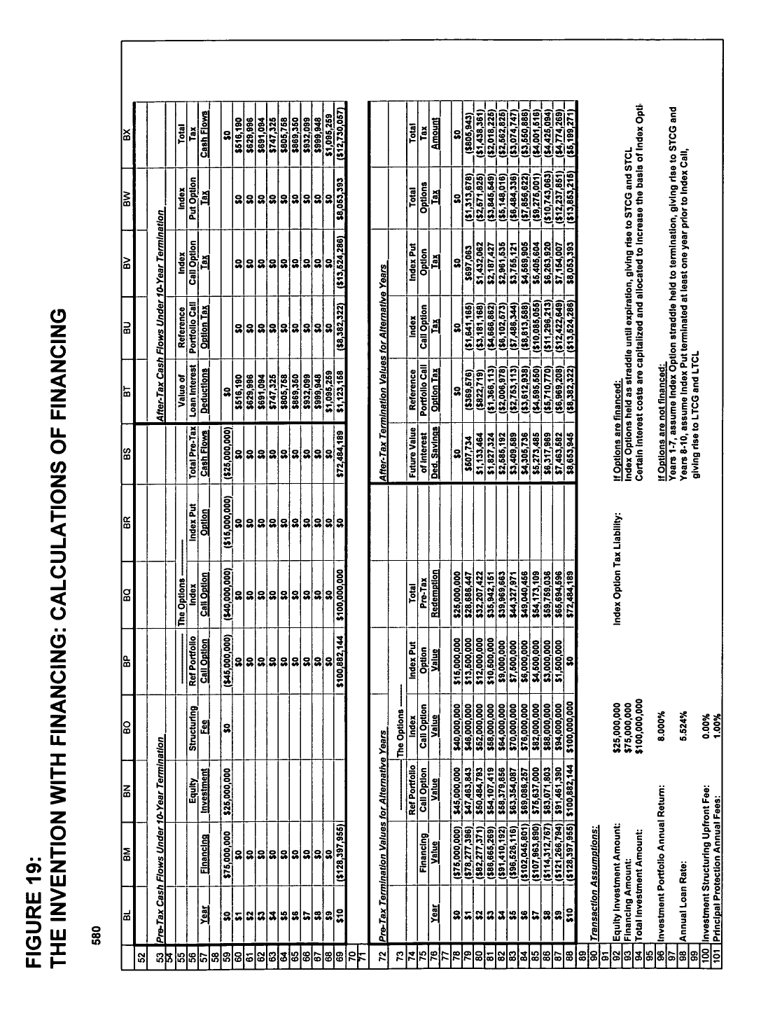

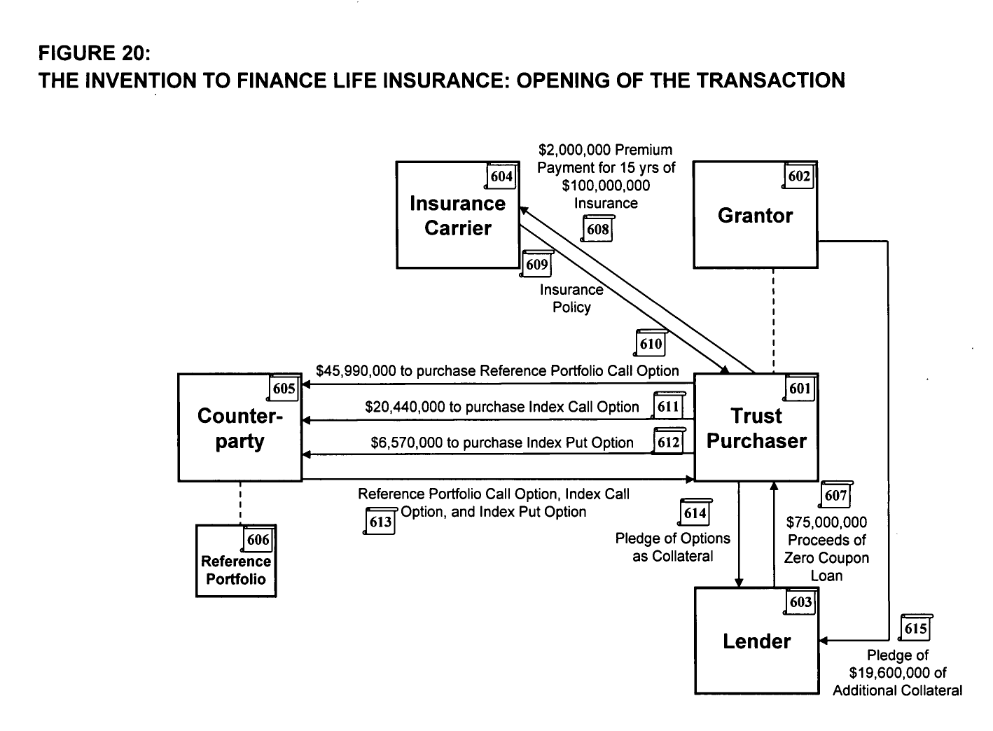

This embodiment is described in greater detail in FIGS. 20, 21, 22, and 23.

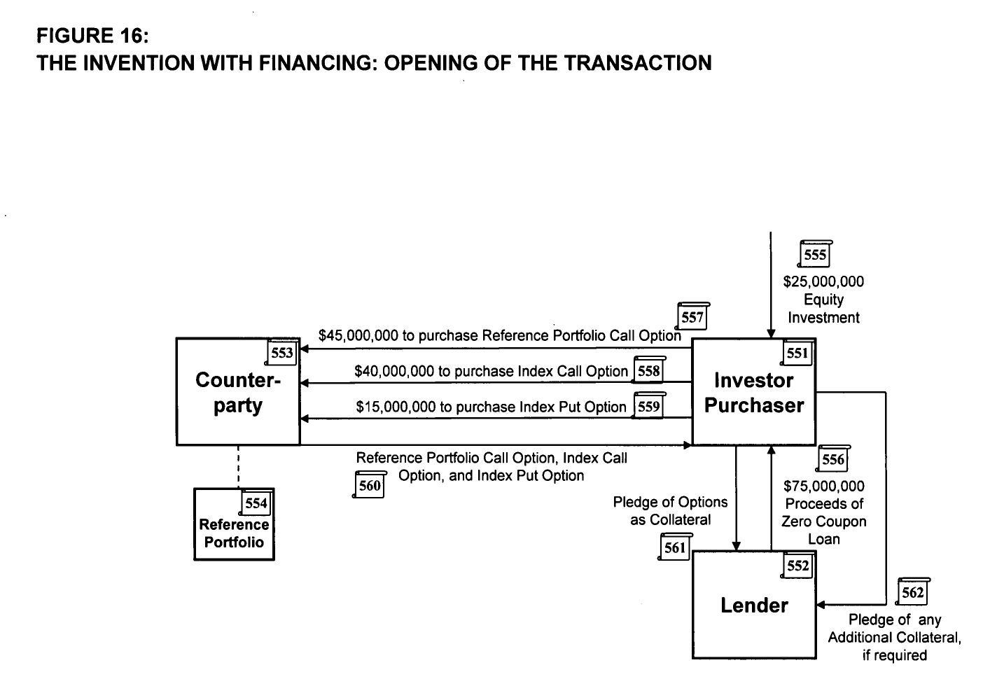

FIGS. 16, 17, 18, 19 provide an illustrative teaching of a description and analysis of leveraged purchase of the options. FIG. 16 displays a diagram of an execution of such an embodiment. In this example, the objective of the Purchaser Investor 551 can be to maximize the after-tax return of its long-term investment while retaining downside protection.

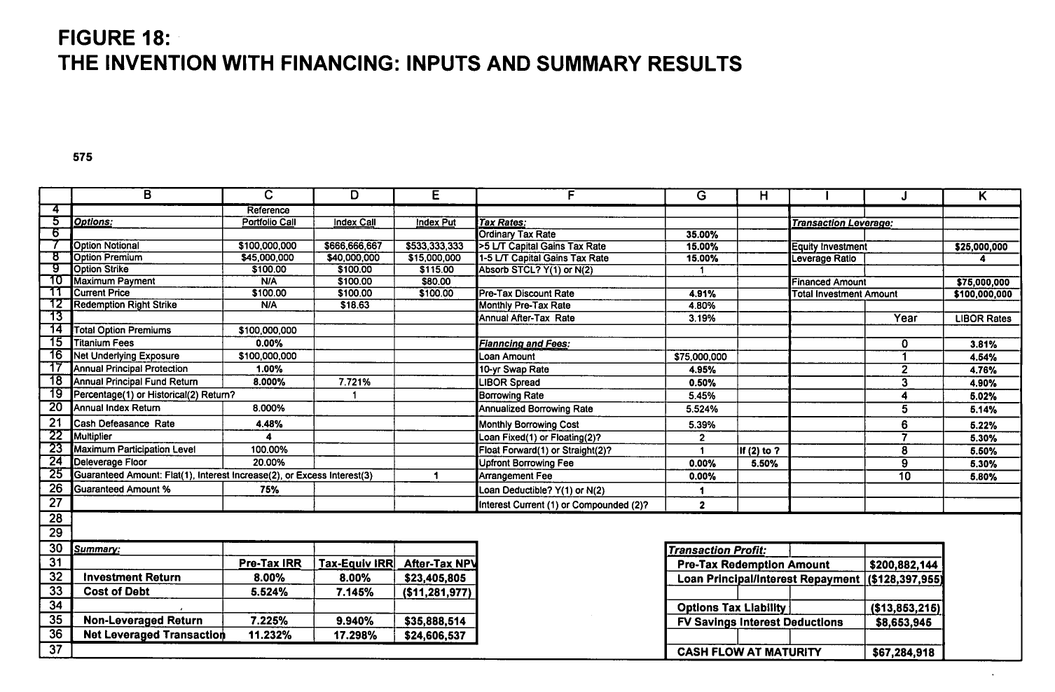

In this example, an Investor Purchaser 551 enters into a 10-year transaction whereby 75% of the cost of the principal-protected investment is financed, as identified in cells K7, K8, and K10 of Spreadsheet 575 in FIG. 18. The Investor Purchaser 551 contributes $25,000,000 of an Equity Investment 555. The Lender 552 lends the Investor Purchaser 551 $75,000,000 through a 10-year non-recourse collateralized Zero Coupon Loan 556, as identified in cell G16 of Spreadsheet 575 in FIG. 18. Interest on the Zero Coupon Loan 556 accrues at a cost of 12-month LIBOR plus 50 bps on a floating rate basis, as identified in cells G18 and G22 of Spreadsheet 575 in FIG. 18. The Investor Purchaser 551 uses its total proceeds of $100,000,000 to purchase the principal-protected investment indexed to the Reference Portfolio 554 from the Counterparty 553, as identified in cell C14 of Spreadsheet 575 in FIG. 18.

The Investor Purchaser 551 pays $45,000,000 for the Reference Portfolio Call Option 557, $40,000,000 for the Index Call Option 558, and $15,000,000 for the Index Put Option 559. The specific terms of the Reference Portfolio Call Option 557, Index Call Option 558, and Index Put Option 559 are defined in the cells ranging from C7 to E12 of Spreadsheet 575 in FIG. 18. In exchange for the upfront premium payments, the Investor Purchaser 551 takes possession of the Options 560.

Because the Zero Coupon Loan 556 is to be collateralized, the Investor Purchaser 551 pledges the Options 560 as Options Collateral 561 to the Lender 552. Depending upon the risk characteristics of the Reference Portfolio 554, a haircut is applied to the Options Collateral 561. In this case, the Options Collateral 561 is sufficient to initially collateralize the Zero Coupon Loan 556. However, because the Zero Coupon Loan 556 is subject to margin variation requirements, Additional Collateral 562 may be required. Additional Collateral 562 may be composed of cash, marketable securities, or a letter of credit, each subject to its own applicable haircut, if any.

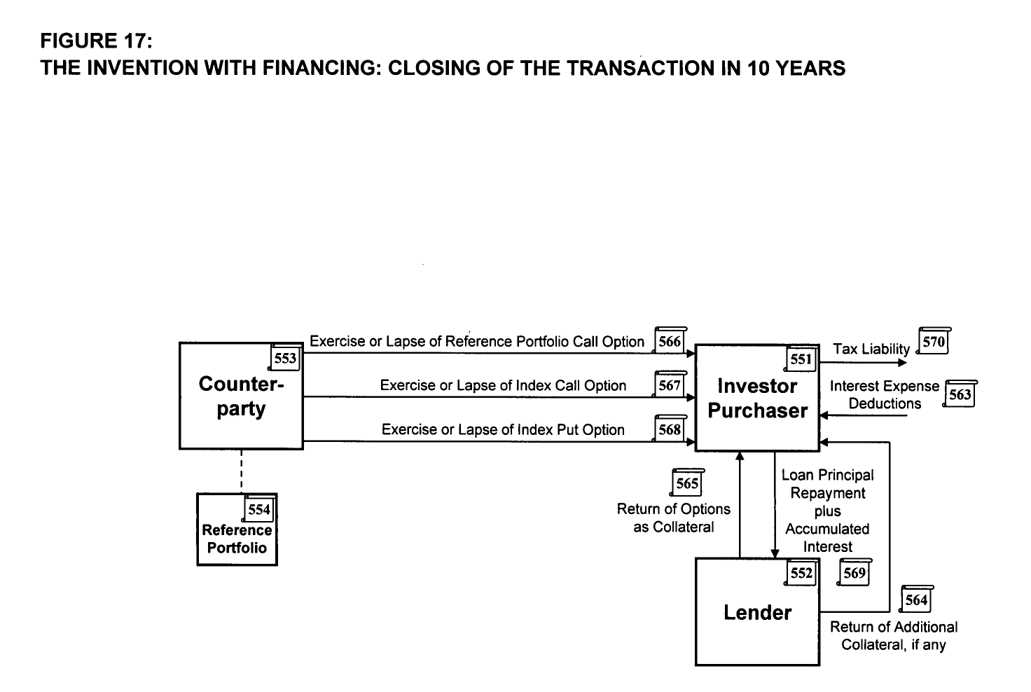

FIG. 17 displays a diagram of the termination of such an embodiment, irrespective of whether such termination occurs at or prior to the scheduled maturity date in 10 years. Subject to the margin variation requirements and depending upon the performance of the Reference Portfolio 554 relative to the accrued value of the Zero Coupon Loan 556, Additional Collateral 564 may be called for or returned if ever initially pledged. This relative performance for each year of the transaction is displayed in cells BQ78 to BQ88 in Spreadsheet 580 of FIG. 19. In this case, the Zero Coupon Loan 556 is simulated to accrue at floating interest rates equal to the forward rates defined in cells K15 to K24 in Spreadsheet 575 of FIG. 18 plus the constant spread of 0.50% identified in cell G18 in Spreadsheet 575 of FIG. 18. The mark-to-market values of the Zero Coupon Loan 556 and of each of the Options 560 for each year is displayed in the cells ranging from BM78 to BP88 in Spreadsheet 580 in FIG. 19. In addition, the investment fund within the Reference Portfolio 554 is assumed to increase at 8% per annum, as depicted in cell C18 in Spreadsheet 575 of FIG. 18. The Reference Portfolio 554 itself is subject to an Annual Principal Protection fee of 1.00%, as defined in cell C17 of Spreadsheet 575 of FIG. 18.

During the holding period of the transaction, the Zero Coupon Loan 556 gives rise to certain Interest Expense Deductions 563, subject to the limitations of sufficient net investment income. The value of the Interest Expense Deductions 563 is equal to such amounts multiplied by the ordinary tax rate of 35% defined in cell G6 of Spreadsheet 575 in FIG. 18. The values of the Interest Expense Deductions 563 are displayed in cells BT60 to BT69 for each year and BS79 to BS88 on a cumulative basis in Spreadsheet 580 of FIG. 19. The cumulative after-tax future value of the Interest Expense Deductions 563 is $8,653,945, as defined in cell BS88 of Spreadsheet 580 in FIG. 19.

Upon termination of the transaction, the Lender 552 initiates a Collateral Return 565 of the Options 560 back to the Investor Purchaser 551. The Investor Purchaser 551 can exercise, terminate, or allow to lapse each of the Options 560. In this simulation it is assumed that the Investor Purchaser 551 executes a Reference Portfolio Call Option Exercise 566, an Index Call Option Exercise 567, and an Index Put Option Lapse 568, generating two payments from the Counterparty 553 to the Investor Purchaser 551. The Investor Purchaser 551 uses the Options 560 redemption amounts for the Zero Coupon Loan Repayment 569 to the Lender 552. Under this scenario, it is calculated that the Reference Portfolio Call Option Exercise 566 amount is $100,882,144, as depicted in cell BP69 of Spreadsheet 580 of FIG. 19, and the Index Call Option Exercise 567 amount is $100,000,000, as depicted in cell BQ69 of Spreadsheet 580 of FIG. 19, for a combined redemption amount of $200,882,144. Under the interest rate assumptions used in this scenario, the Zero Coupon Loan Repayment 569 amount is $128,397,955, representing an annualized cost of 5.52%, as depicted in cell C33 of Spreadsheet 575 of FIG. 18.

Each of the Options 560 gives rise to a taxable event upon their termination or lapse, generating a Tax Liability 570 at termination. The Reference Portfolio Call Option 557 gives rise to a tax liability of $8,382,322, as depicted in cell BU69 of Spreadsheet 580 of FIG. 19, while the Index Call Option 558 gives rise to a tax liability of $13,524,286, as depicted in cell BV69 of Spreadsheet 580 of FIG. 19. The Index Put Option 559 gives rise to a tax deduction of $8,053,393, as depicted in cell BW69 of Spreadsheet 580 of FIG. 19.

The results of this example are depicted in cells J31 to J37 and cells C32 to E36 of Spreadsheet 575 in FIG. 18. The pre-tax net redemption amount of the transaction at maturity is a positive payment of $72,484,189, representing a pre-tax annualized return of 11.23%, as defined in cell C36 of Spreadsheet 575 of FIG. 18.

While the Tax Liability 570 at maturity resulting from the Options 560 is $13,853,215, this amount is offset by the future value of the tax savings resulting from the Interest Expense Deductions 563, an amount equal to $8,653,945. Consequently, the after-tax redemption amount resulting in this example is $67,284,918, representing a taxable-equivalent annualized return of 17.30%, as defined in cell D36 of Spreadsheet 575 of FIG. 18.

Under the 8.00% investment portfolio return scenario, leverage increases the taxable-equivalent annualized return of a straight investment by 323 bps, from 8.00% to 11.23%. On the other hand, leverage increases the annual return of the embodiment by 1015 bps, from 7.15% to 17.30%. This means that the tax efficiency of the embodiment in this example is 607 bps per annum, from 11.23% to 17.30%.

In another embodiment the maturity of the transaction can be shorter or longer.

In another embodiment the Index Call Option 558 and the Index Put Option 559 are structured such that the Index Put Option 559 has a larger maximum payout than that of the Index Call Option 558 and the Reference Portfolio 554 is expected to decline rather than increase.

In another embodiment the amount of borrowing relative to the Investor Purchaser 551's equity investment, if any, can range from zero to an amount greater than the cost of the Options 560.

In another embodiment the Zero Coupon Loan 556 can accrue interest on a fixed rate basis for all or some of its maturity.

In another embodiment the floating interest rates at which the Zero Coupon Loan 556 can accrue are higher or lower than that depicted in this example.

In another embodiment the actual or simulated return of the investment portfolio indexed to the Reference Portfolio 554 can be higher or lower than that depicted in this example.

In another embodiment the Lender 552 and Counterparty 553 can be the same entity.

Turn now to FIGS. 20, 21, 22, 23 for a representative illustration of a description and analysis of a leveraged purchase of the options to finance life insurance. FIG. 20 displays a diagram of the execution of one such embodiment. In this embodiment, the objective of the Grantor 602 can be to acquire a large amount of life insurance outside of its estate with no out-of-pocket cost. This embodiment addresses the estate and gift tax constraints of financing and acquiring life insurance outside of the estate. This embodiment uses a financing for both the payment of an initial life insurance premium and the purchase of a principal-protected investment. The objective of this embodiment can be to generate a pre-tax profit beyond the cost of borrowing in order to pay a pre-defined Catch-Up Premium 624 so that the Insurance Policy 625 is fully paid-up for life.

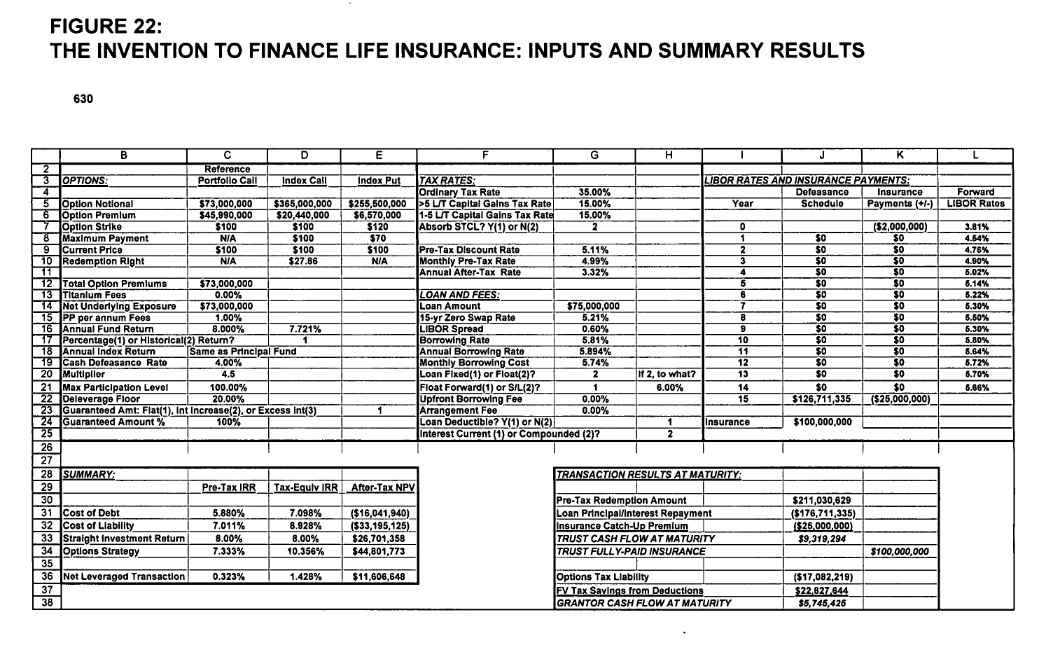

In this example, a Grantor 602 establishes or uses an existing trust, typically an irrevocable life insurance trust. The trust is typically a defective income grantor trust and acts as the Trust Purchaser 601. The Trust Purchaser 601 enters into a 15-year transaction whereby the Trust Purchaser 601 contributes no cash and borrows a certain loan amount. The Lender 603 lends the Trust Purchaser 601 $75,000,000 through a 15-year non-recourse collateralized Zero Coupon Loan 607, as identified in G14 of Spreadsheet 630 in FIG. 22. Interest on the Zero Coupon Loan 607 accrues at a cost of 12-month LIBOR plus 60 bps on a floating rate basis, as identified in cells G16 and G20 of Spreadsheet 630 in FIG. 22. The Trust Purchaser 601 uses a portion of the $75,000,000 to make an initial premium payment for a life insurance policy and to purchase a principal-protected investment indexed to the Reference Portfolio 606 from the Counterparty 605.

The Trust Purchaser 601 pays the initial Premium Payment 608 of $2,000,000 for a $100,000,000 guaranteed no-lapse life Insurance Policy 609, the cost of which is indicated in cell K7 of Spreadsheet 630 in FIG. 22. Upon payment of the Premium Payment 608 to the Insurance Carrier 604, the Insurance Policy 609 provides a $100,000,000 guaranteed death benefit for 15 years without any further premium payments due. In order to maintain the Insurance Policy 609 in force beyond the 15th year, the Trust Purchaser 601 will have to pay additional premiums. Such additional premiums may either be one lump-sum Catch-Up Premium 624 to maintain a guaranteed death benefit for life or smaller annual premiums to carry the death benefit year-to-year. The Trust Purchaser 601 now owns the Insurance Policy 609 outside of the estate of the Grantor 602.

The Trust Purchaser 601 now uses the remaining proceeds of $73,000,000, identified in cell C12 in Spreadsheet 630 of FIG. 22, from the Zero Coupon Loan 607 to purchase a principal-protected investment composed of the Options 613. The Trust Purchaser 601 pays $45,990,000 for the Reference Portfolio Call Option 610, $20,440,000 for the Index Call Option 611, and $6,570,000 for the Index Put Option 612. The specific terms of the Reference Portfolio Call Option 610, Index Call Option 611, and Index Put Option 612 are defined in the cells ranging from C5 to E10 of Spreadsheet 630 in FIG. 22. In exchange for the upfront premium payments, the Trust Purchaser 601 takes possession of the Options 613.

Because the Zero Coupon Loan 607 is to be collateralized, the Trust Purchaser 601 pledges the Options 613 as Options Collateral 614 to the Lender 603. Depending upon the risk characteristics of the Reference Portfolio 606, a haircut is applied to the Options Collateral 614. In this case, the Options Collateral 614 is insufficient to initially collateralize the entire Zero Coupon Loan 607. As a result, the Lender 603 requires $19,600,000 of Additional Collateral 615 upfront to adequately collateralize the Zero Coupon Loan 607. Additional Collateral 615 may be composed of cash, marketable securities, or a letter of credit, each subject to its own applicable haircut, if any. In this example, the Grantor 602 pledges the Additional Collateral 615. The Zero Coupon Loan 607 is subject to margin variation.

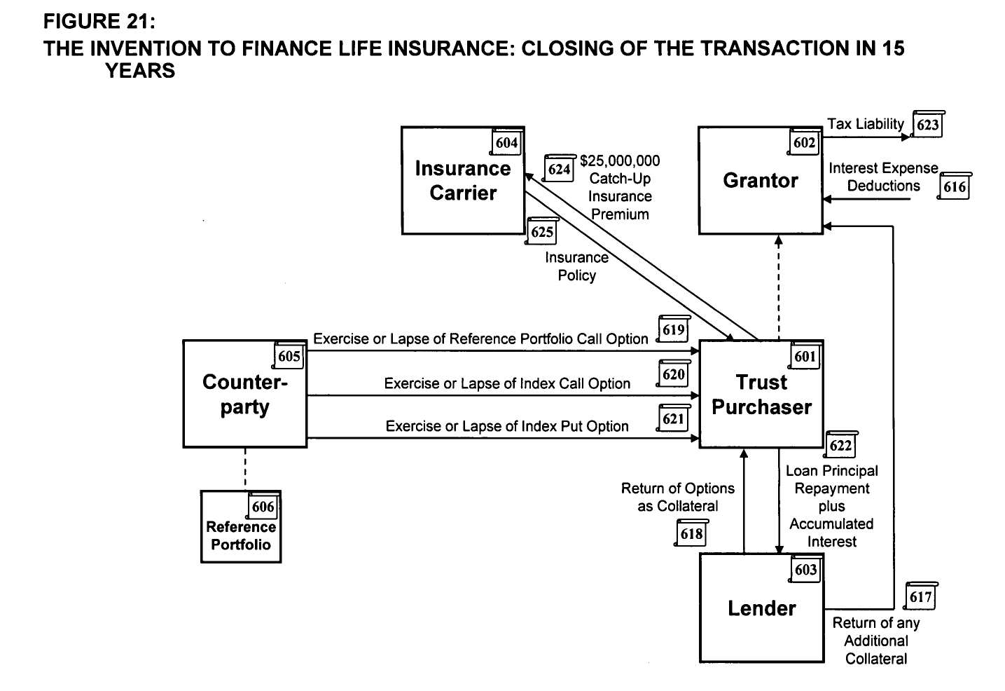

FIG. 21 displays a diagram of the termination of this embodiment, irrespective of whether such termination occurs at or prior to the scheduled maturity date in 15 years. The objective of the transaction can be for the Trust Purchaser 601 to generate a redemption amount from the Options 613 sufficient to execute a Zero Coupon Loan Repayment 622 and pay the Catch-Up Premium 624.

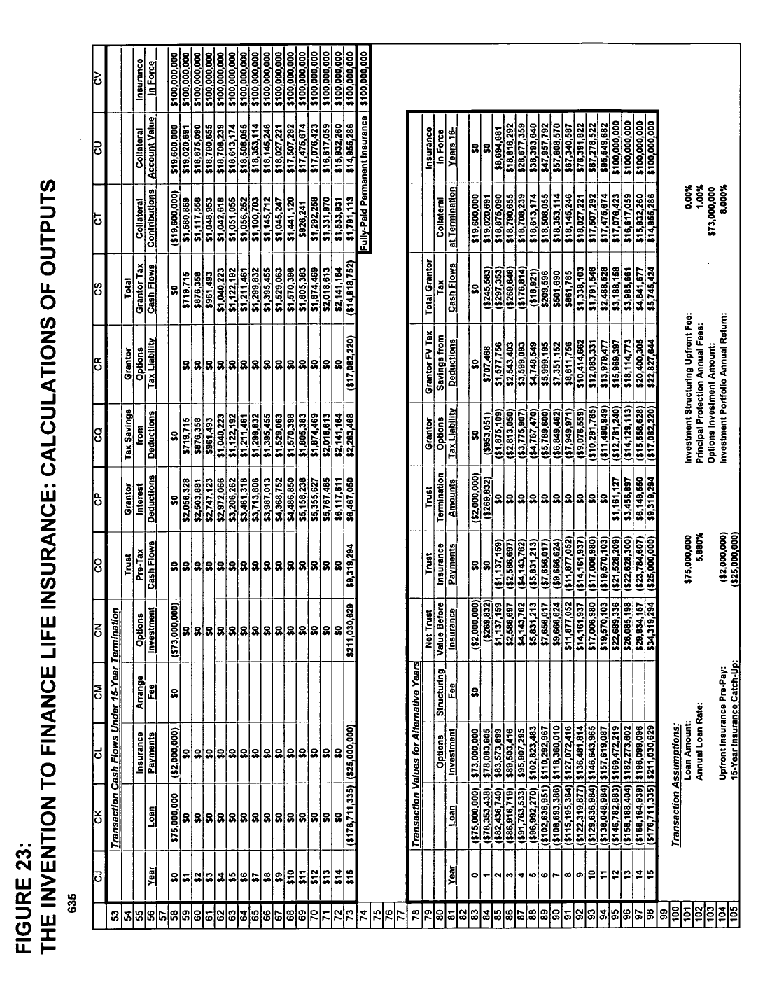

Subject to the margin variation requirements and depending upon the performance of the Reference Portfolio 606 relative to the accrued value of the Zero Coupon Loan 607, Additional Collateral 617 may be called for or returned. This relative performance for each year of the transaction is displayed in cells CN83 to CN98 in Spreadsheet 635 of FIG. 23. In this case, the Zero Coupon Loan 607 is simulated to accrue at floating interest rates equal to the forward rates defined in cells L7 to L21 in Spreadsheet 630 of FIG. 22 plus the constant spread of 0.60% identified in cell G16 in Spreadsheet 630 of FIG. 22. The mark-to-market values for each year of the Zero Coupon Loan 607 are displayed in cells CK83 to CK98 in Spreadsheet 630 in FIG. 23. The mark-to-market values for each year of the Options 613 collectively are displayed in cells CL83 to CL98 in Spreadsheet 630 in FIG. 23. In addition, the investment fund within the Reference Portfolio 606 is assumed to increase at 8% per annum, as depicted in cell C16 in Spreadsheet 630 of FIG. 22. The Reference Portfolio 606 itself is subject to an Annual Principal Protection fee of 1.00%, as defined in cell C15 of Spreadsheet 630 of FIG. 22.

All tax deductions and liabilities arising from transactions executed by the Trust Purchaser 601 flow through to the Grantor 602.

During the holding period of the transaction, the Zero Coupon Loan 607 gives rise to certain Interest Expense Deductions 616, subject to the limitations of sufficient net investment income. The value of the Interest Expense Deductions 616 is equal to such amounts multiplied by the ordinary tax rate of 35% defined in cell G4 of Spreadsheet 630 in FIG. 22. The values of the Interest Expense Deductions 616 are displayed in cells CQ59 to CQ73 for each year and cells CR84 to CR98 on a cumulative basis in Spreadsheet 635 of FIG. 23. The cumulative after-tax future value of the Interest Expense Deductions 616 is $22,827,644, as defined in cell CR98 of Spreadsheet 635 in FIG. 23.

Upon termination of this sample transaction, the Lender 603 initiates a Collateral Return 618 of the Options 613 back to the Trust Purchaser 601. The Trust Purchaser 601 exercises, terminates, or allows to lapse each of the Options 613. In this simulation it is assumed that the Trust Purchaser 601 executes a Reference Portfolio Call Option Exercise 619, an Index Call Option Exercise 620, and an Index Put Option Lapse 621, generating two payments from the Counterparty 605 to the Trust Purchaser 601. The Trust Purchaser 601 uses the Options 613 redemption amounts for the Zero Coupon Loan Repayment 622 to the Lender 603. Under this scenario, it is calculated that the Reference Portfolio Call Option Exercise 619 amount is $138,030,629 and the Index Call Option Exercise 567 amount is $73,000,000, as depicted collectively in cell CN73 of Spreadsheet 635 of FIG. 23. Under the interest rate assumptions used in this scenario, the Zero Coupon Loan Repayment 622 amount is $176,711,335, representing an annualized cost of 5.88%, as depicted in cell C31 of Spreadsheet 630 of FIG. 22.

Each of the Options gives rise to a taxable event upon their termination or lapse, generating a Tax Liability 623 at termination. The net tax liability of the Options 613 at maturity is $17,082,220, as depicted in cell CR73 of Spreadsheet 635 of FIG. 23.

The results of this example are depicted in the cells ranging from J30 to K38 and cells C31 to E36 of Spreadsheet 630 in FIG. 22. The net redemption amount of the transaction at maturity for the Trust Purchaser 601 is a profit of $34,319,294, as represented by the difference between cells J30 and J31 of Spreadsheet 630 in FIG. 22.

The Trust Purchaser 601 can use any portion of its profit, which is outside of the estate of the Grantor 602, to pay-up any portion of the Insurance Policy 625. Because the Trust Purchaser 601 generates a profit in excess of the full Catch-Up Premium 624, it can pay the full $25,000,000 Catch-Up Premium 624 to the Insurance Carrier 604 to pay-up for life the full $100,000,000 Insurance Policy 625, as depicted in cell K34 of Spreadsheet 630 in FIG. 22. Under this scenario, even after having paid the full Catch-Up Premium 624, the Trust Purchaser 601 has a residual profit of $9,319,294, as calculated in cell J33 of Spreadsheet 630 in FIG. 22.

The acquisition of the fully paid-up Insurance Policy 625 is of significant value to the Grantor 602, because it can be achieved with no out-of-pocket cost, no gift taxes, and a death benefit free of estate taxes.

Any residual profit earned by the Trust Purchaser 601 resulting from the embodiment is also of significant value to the Grantor 601, because such profit can be generated without gift taxes or estate taxes.

The Grantor 601 is responsible for any tax liabilities arising from the transaction. While the Tax Liability 623 at maturity resulting from the Options 613 is $17,082,219, this amount is offset by the future value of the tax savings resulting from the Interest Expense Deductions 616, an amount equal to $22,8827,644. Consequently, the Grantor 601 generates a net tax benefit of $5,745,425 from this transaction, as calculated in cell J38 of Spreadsheet 630 in FIG. 22.

In another embodiment the maturity of the transaction can be shorter or longer.

In another embodiment the Index Call Option 611 and the Index Put Option 612 can be structured such that the Index Put Option 612 has a larger maximum payout than the Index Call Option 611 and the Reference Portfolio 606 is expected to decline rather than increase.

In another embodiment the amount of borrowing can be increased or decreased depending upon the Grantor 601's tolerance for risk and availability of Additional Collateral 615.

In another embodiment the Zero Coupon Loan 607 can accrue interest on a fixed rate basis for all or some of its maturity.

In another embodiment the floating interest rates at which the Zero Coupon Loan 607 can accrue are higher or lower than that depicted in this example.

In another embodiment the actual or simulated return of the investment portfolio indexed to the Reference Portfolio 606 can be higher or lower than that depicted in this example.

In another embodiment the Lender 603 and Counterparty 605 can be the same entity.

In another embodiment the Trust Purchaser 601 can be a trust that is not a defective income trust or an irrevocable life insurance trust.

In another embodiment the Trust Purchaser 601 can not be a trust.

In another embodiment the Trust Purchaser 601 can be any business entity such as a corporation or a partnership that is acquiring life insurance policies on any of its executives, partners, members, or employees.

In another embodiment the Trust Purchaser 601 can be any business entity such as a corporation or a partnership that is acquiring life insurance policies on any of its executives, partners, members, or employees in order to hedge its unfunded nonqualified benefit obligations.

In another embodiment the Additional Collateral 615 can be pledged fully or partially from the Trust Purchaser 601.

In another embodiment the Grantor can elect to lend all or any portion of the cash to the Trust Purchaser 601 in lieu of the Lender 603 acting as the sole lending institution.

In another embodiment the Trust Purchaser 601 can elect to purchase a life insurance policy that is not structured as a guaranteed no-lapse policy.

In another embodiment the Trust Purchaser 601 can elect to finance the transaction for the purposes of carrying the Insurance Policy 609 during the initial period and not allocate any profit to the payment of the Catch-Up Premium 624.

In another embodiment the Trust Purchaser 601 can instead pay annual premiums for the Insurance Policy 625 to carry the policy year-to-year rather than paying the full Catch-Up Premium 624.

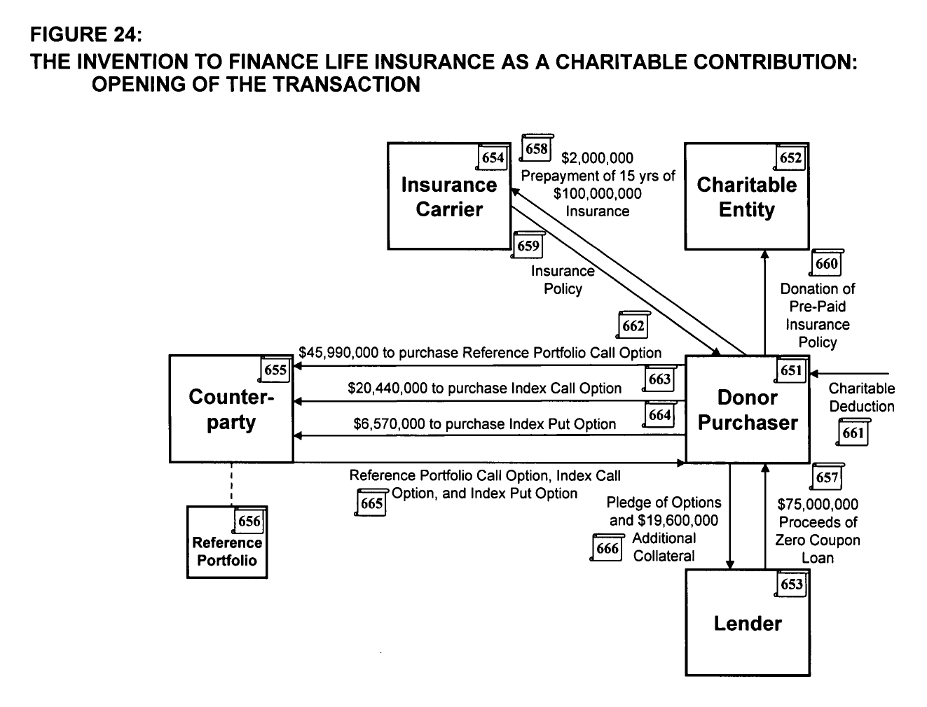

Turn now to FIGS. 24, 25, 26, 27 for an illustrative description and analysis of leveraged purchase of options to finance life insurance as a charitable contribution. FIG. 24 displays a teaching example diagram of the execution of an embodiment. In this embodiment, the objective of the Donor Purchaser 651 is to finance the purchase of a large amount of life insurance inside of the estate with no out-of-pocket cost for the purposes of donating a life insurance policy to a Charitable Entity 652. This embodiment is similar to that embodiment described in FIGS. 20, 21, 22, and 23 with two exceptions. First, the Donor Purchaser 651 typically executes all transactions inside rather than outside of the estate, because the beneficiary is the Charitable Entity 652 not subject to estate taxes and any contributions or payments made by the Donor Purchaser 651 are not subject to gift tax. Second, the Donor Purchaser 651 makes potentially two charitable contributions: the Insurance Policy 659 and a future Cash Donation 673.

This embodiment uses a financing for both the payment of an initial life insurance premium and the purchase of a principal-protected investment. Once the Insurance Policy 659 is acquired by the Donor Purchaser 651, the Donor Purchaser 651 contributes the Insurance Policy 659 to the Charitable Entity 652. The objective of this embodiment can be to generate a profit beyond the cost of borrowing in order for the Donor Purchaser 651 to make a future Cash Donation 673 to the Charitable Entity 652 sufficient to pay the Catch-Up Premium 674 to fully pay-up the life insurance policy for life.

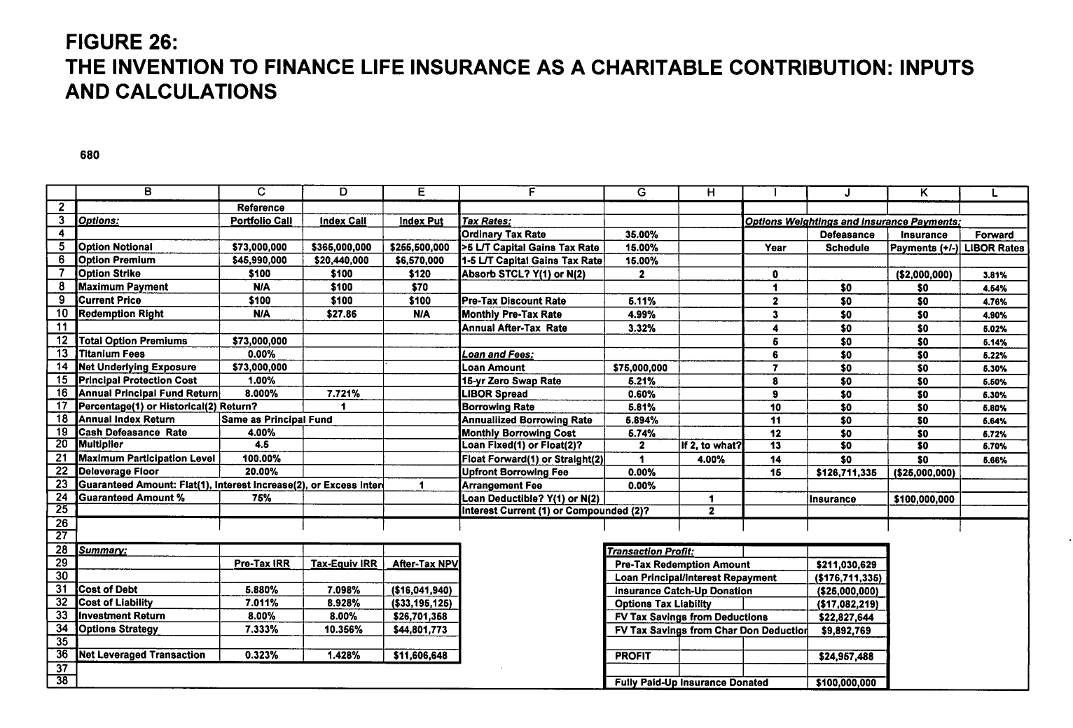

In this example, the Donor Purchaser 651 enters into a 15-year transaction whereby the Donor Purchaser 651 contributes no cash and borrows a certain loan amount. The Lender 653 lends the Donor Purchaser 651 $75,000,000 through a 15-year non-recourse collateralized Zero Coupon Loan 657, as identified in G14 of Spreadsheet 680 in FIG. 26. Interest on the Zero Coupon Loan 657 accrues at a cost of 12-month LIBOR plus 60 bps on a floating rate basis, as identified in cells G16 and G20 of Spreadsheet 650 in FIG. 26. The Donor Purchaser 651 uses a portion of the $75,000,000 to make an initial premium payment for a life insurance policy and to purchase a principal-protected investment indexed to the Reference Portfolio 656 from the Counterparty 655.

The Donor Purchaser 651 pays the initial Premium Payment 658 of $2,000,000 for a $100,000,000 guaranteed no-lapse life Insurance Policy 659, the cost of which is indicated in cell K7 of Spreadsheet 650 in FIG. 26. Upon payment of the Premium Payment 658 to the Insurance Carrier 654, the Insurance Policy 659 provides a $100,000,000 guaranteed death benefit for 15 years without any further premium payments due. In order to maintain the Insurance Policy 659 in force beyond the 15th year, the Donor Purchaser 651 will have to pay additional premiums. Such additional premiums may either be one lump-sum Catch-Up Premium 675 to maintain a guaranteed death benefit for life or smaller annual premiums to carry the death benefit year-to-year.

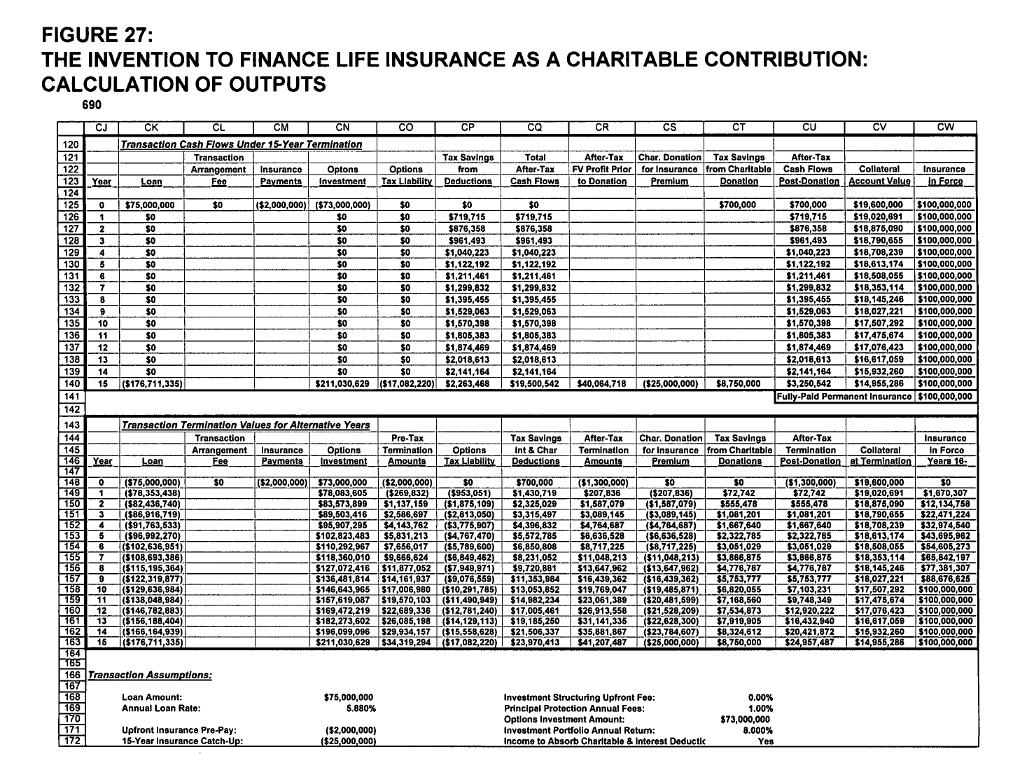

The Donor Purchaser 651 now owns the Insurance Policy 659. Within one year of its purchase, the Donor Purchaser 651 executes the Donation 660 of the Insurance Policy 659 to the Charitable Entity 652. As a result of the Donation 660, the Donor Purchaser 651 receives a Charitable Deduction 661. The value of this tax deduction is $700,000, as defined in cell CT125 of Spreadsheet 690 in FIG. 27.

The Donor Purchaser 651 uses the remaining proceeds of $73,000,000, identified in cell C12 in Spreadsheet 680 of FIG. 26, from the Zero Coupon Loan 657 to purchase a principal-protected investment composed of the Options 665. The Donor Purchaser 651 pays $45,990,000 for the Reference Portfolio Call Option 662, $20,440,000 for the Index Call Option 663, and $6,570,000 for the Index Put Option 664. The specific terms of the Reference Portfolio Call Option 662, Index Call Option 663, and Index Put Option 664 are defined in the cells ranging from C5 to E10 of Spreadsheet 680 in FIG. 26. In exchange for the upfront premium payments, the Donor Purchaser 651 takes possession of the Options 665.

Because the Zero Coupon Loan 657 is to be collateralized, the Donor Purchaser 651 pledges the Options 665 as Collateral 666 to the Lender 653. Depending upon the risk characteristics of the Reference Portfolio 656, a haircut is applied to the Options 665 as Collateral 666. In this case, the Options 665 are insufficient to initially collateralize the entire Zero Coupon Loan 657. As a result, the Lender 653 requires $19,600,000 of additional Collateral 666 upfront to adequately collateralize the Zero Coupon Loan 657. additional Collateral 666 may be composed of cash, marketable securities, or a letter of credit, each subject to its own applicable haircut, if any. The Zero Coupon Loan 657 is subject to margin variation.

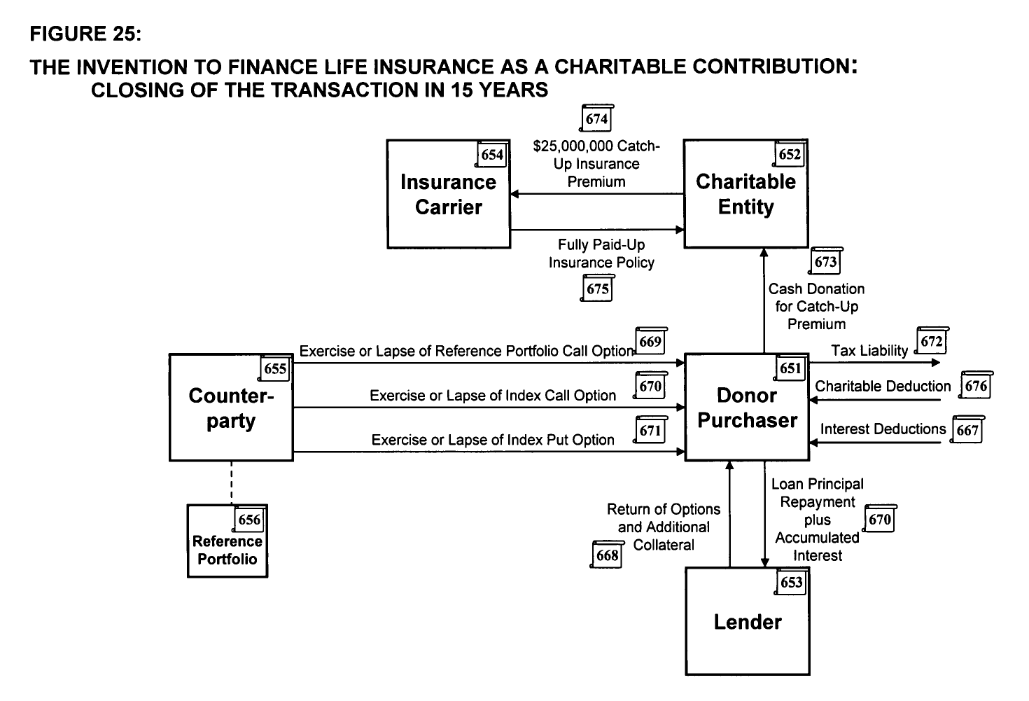

FIG. 25 displays a diagram of the termination of this embodiment, irrespective of whether such termination occurs at or prior to the scheduled maturity date in 15 years. The objective of the transaction is for the Donor Purchaser 651 to generate a redemption amount from the Options 665 sufficient to execute a Zero Coupon Loan Repayment 670 and generate a net profit equal to the $25,000,000 Catch-Up Premium 674.

Subject to the margin variation requirements and depending upon the performance of the Reference Portfolio 656 relative to the accrued value of the Zero Coupon Loan 657, additional Collateral 666 may be called for or returned. This relative performance for each year of the transaction is displayed in cells CO148 to CO163 in Spreadsheet 690 of FIG. 27. In this case, the Zero Coupon Loan 657 is simulated to accrue at floating interest rates equal to the forward rates defined in cells L7 to L21 in Spreadsheet 680 of FIG. 26 plus the constant spread of 0.60% identified in cell G16 in Spreadsheet 680 of FIG. 26. The mark-to-market values for each year of the Zero Coupon Loan 657 are displayed in cells CK148 to CK163 in Spreadsheet 690 in FIG. 27. The mark-to-market values for each year of the Options 665 collectively are displayed in cells CN148 to CN163 in Spreadsheet 690 in FIG. 27. In addition, the investment fund within the Reference Portfolio 656 is assumed to increase at 8% per annum, as depicted in cell C16 in Spreadsheet 680 of FIG. 26. The Reference Portfolio 656 itself is subject to an Annual Principal Protection fee of 1.00%, as defined in cell C15 of Spreadsheet 680 of FIG. 26.

During the holding period of the transaction, the Zero Coupon Loan 657 gives rise to certain Interest Expense Deductions 667, subject to the limitations of sufficient net investment income. The value of the Interest Expense Deductions 667 is equal to such amounts multiplied by the ordinary tax rate of 35% defined in cell G4 of Spreadsheet 680 in FIG. 26. The values of the Interest Expense Deductions 667 for each year are displayed in cells CP126 to CP140 in Spreadsheet 690 of FIG. 27. The combined cumulative values of the Interest Expense Deductions 667 and the initial Charitable Deduction 661 are displayed in cells CQ148 to CQ163 in Spreadsheet 690 of FIG. 27. The combined cumulative after-tax future value of the Interest Expense Deductions 667 and the initial Charitable Deduction 661 is $23,970,413, as defined in cell CQ163 of Spreadsheet 690 in FIG. 27.

Upon termination of the transaction, the Lender 653 initiates a Collateral Return 668 of the Options 665 and any additional Collateral 666 back to the Donor Purchaser 651. The Donor Purchaser 651 either exercises, terminates, or allows to lapse each of the Options 665. In this simulation it is assumed that the Donor Purchaser 651 executes a Reference Portfolio Call Option Exercise 669, an Index Call Option Exercise 670, and an Index Put Option Lapse 671, generating two payments from the Counterparty 655 to the Donor Purchaser 651. The Donor Purchaser 651 uses the Options 665 redemption amounts for the Zero Coupon Loan Repayment 670 to the Lender 653. Under this scenario, it is calculated that the Reference Portfolio Call Option Exercise 669 amount is $138,030,629 and the Index Call Option Exercise 670 amount is $73,000,000, as depicted collectively in cell CN73 of Spreadsheet 690 of FIG. 27. Under the interest rate assumptions used in this scenario, the Zero Coupon Loan Repayment 670 amount is $176,711,335, representing an annualized cost of 5.88%, as depicted in cell C31 of Spreadsheet 680 of FIG. 26.

Each of the Options gives rise to a taxable event upon their termination or lapse, generating a Tax Liability 672 at termination. The net tax liability of the Options 665 at maturity is $17,082,220, as depicted in cell CO140 of Spreadsheet 690 in FIG. 27.

The results of this example are depicted in the cells ranging from J29 to J38 and cells C31 to E36 of Spreadsheet 680 in FIG. 26. The net redemption amount of the transaction at maturity for the Donor Purchaser 651 is a profit of $34,319,294, as represented by the difference between cells J29 and J30 of Spreadsheet 680 in FIG. 26.

Although the Donor Purchaser 651 is not required to do so, the transaction assumes that the Donor Purchaser 651 can use any of its future profit up to $25,000,000 resulting from the transaction to contribute as a Cash Donation 673 to the Charitable Entity 652. Since the Donor Purchaser 651 generates a profit in excess of $25,000,000, it can pay the full $25,000,000 Cash Donation 673 to the Charitable Entity 652. In turn, the Charitable Entity may not be obligated to use the Cash Donation 673 to pay the Catch-Up Premium 674 but it is assumed that it will do so. Thus, the Charitable Entity 652 can use the $25,000,000 Cash Donation 573 to pay the full Catch-Up Premium 674 to the Insurance Carrier 604. Payment of the full Catch-Up Premium 674 provides the Charitable Entity 652 a $100,000,000 Fully Paid-Up Insurance Policy 675, as depicted in cell J38 of Spreadsheet 680 in FIG. 26.

Under this scenario, even after having paid the full Cash Donation 673, the Donor Purchaser 651 has a residual pre-tax profit of $9,319,294, calculated as the difference of the cells J29, J30, and J31 of Spreadsheet 680 in FIG. 26.

In addition to fully accomplishing the acquisition and donation of a Fully Paid-Up Insurance Policy 675 and a pre-tax profit of $9,319,294, this embodiment generates significant tax benefits to the Donor Purchaser 651. The Tax Liability 672 at maturity resulting from the redemption of the Options 665 is $17,082,219, defined in cell J32 of Spreadsheet 680 in FIG. 26. But this amount is offset by numerous deductions. The after-tax future value of the tax savings resulting from the Interest Expense Deductions 667 is $22,8827,644, defined in cell J33 of Spreadsheet 680 in FIG. 26. And the after-tax future value of the tax savings resulting from the initial Charitable Deduction 661 and Charitable Deduction 676 is $9,892,769, defined in cell J34 of Spreadsheet 680 in FIG. 26. Consequently, the Donor Purchaser 651 generates a net tax benefit of $15,638,194 from this transaction, resulting in a net after-tax profit of $24,957,488, as calculated in cell J36 of Spreadsheet 680 in FIG. 26.

In another embodiment the maturity of the transaction can be shorter or longer.

In another embodiment the Index Call Option 663 and the Index Put Option 664 can be structured such that the Index Put Option 664 has a larger maximum payout than the Index Call Option 663 and the Reference Portfolio 656 is expected to decline rather than increase.

In another embodiment the amount of borrowing can be increased or decreased depending upon the Donor Purchaser 651's tolerance for risk and availability of additional Collateral 666.

In another embodiment the amount of borrowing can be increased or decreased depending upon the Donor Purchaser 651's election to use its own cash.

In another embodiment the Zero Coupon Loan 657 can accrue interest on a fixed rate basis for all or some of its maturity.

In another embodiment the floating interest rates at which the Zero Coupon Loan 657 can accrue are higher or lower than that depicted in this example.

In another embodiment the actual or simulated return of the investment portfolio indexed to the Reference Portfolio 656 can be higher or lower than that depicted in this example.

In another embodiment the Lender 653 and Counterparty 655 can be the same entity.

In another embodiment the additional Collateral 666 can be pledged fully or partially from the Donor Purchaser 651.

In another embodiment the Donor Purchaser 651 can elect to purchase a life insurance policy that is not structured as a guaranteed no-lapse policy.

In another embodiment the Charitable Entity 652 can instead elect to pay annual premiums for the Insurance Policy 675 to carry the policy year-to-year rather than paying the full Catch-Up Premium 674.

In another embodiment the Charitable Entity 652 can instead elect to use the Cash Donation 673 for other purposes than paying the Catch-Up Premium 674.

In another embodiment a pool of Donor Purchasers 651 can organize collectively to execute substantially similar transactions.

Although only a few exemplary embodiments have been described in detail above, those skilled in the art will readily appreciate that many modifications are possible in the exemplary embodiments without materially from the novel teachings and advantages herein. Accordingly, all such modifications are intended to be included within the scope defined by claims. In the claims, means-plus-function claims are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment fastening wooden parts, a nail and a screw may be equivalent structures.

1. A computer-aided method of constructing a principal-protected investment indexed to a reference portfolio, the method including the steps of:
entering into a computer a desired principal-protected amount, terms defining a reference portfolio call option indexed to performance of the reference portfolio, terms defining an index call option indexed to an underlying that is not being substantially similar to the reference portfolio, and terms defining an index put option indexed to the underlying; and
controlling said computer with a program to use said principal-protected amount and said terms to generate output including a combined cost of the three options substantially equal to the principal-protected amount, a combined expected payoff at expiration of the index call option and the index put option equal to the cost of the three options and a payoff at expiration of the reference portfolio call option substantially equal to increased value of the reference portfolio.

2. The method of claim 1, wherein said controlling includes indexing the reference portfolio to an investment portfolio.

3. The method of claim 2, wherein the step of controlling includes communicating identity of the investment portfolio to at least one potential counterparty computer; and further including the step of receiving said counterparty's cost to protect the principal-protected amount.

4. The method of claim 1, wherein the step of entering includes entering a notional amount of the reference portfolio call option, said notional amount being substantially equal to the principal-protected amount, a strike price for the reference portfolio call option substantially equal to the notional amount of the reference portfolio call option, an upfront cost for the reference portfolio call option, an expiration date, and a payout formula with no reference to interest cost, and entering a return of the reference portfolio; and wherein said step of controlling the computer includes calculating a payout value of the reference portfolio call option.

5. The method of claim 1, wherein the step of controlling includes communicating identity of the underlying to at least one potential counterparty computer.

6. The method of claim 1, wherein the step of entering includes entering a notional amount of the index call option, a strike price for the index call option, an upfront cost for the index call option, an expiration date, a payout formula, and a maximum payout, and entering a return of the underlying; and wherein said step of controlling the computer includes calculating a payout value of the index call option.

7. The method of claim 1, wherein the step of entering includes entering a notional amount of the index put option, a strike price for the put call option, an upfront cost for the index put option, an expiration date, a payout formula, and a maximum payout, and entering a return of the underlying; and wherein said step of controlling the computer includes calculating a payout value of the index put option.

8. The method of claim 1, wherein the step of entering includes entering an early redemption date and an early redemption amount for one of the index call option and the index put option.

9. The method of claim 1, wherein the step of controlling the computer includes testing that any combination of the options will not be a “conversion transaction” under U.S. Internal Revenue Code section 1258.

10. The method of claim 1, wherein the step of entering includes entering tax rates and at least one formula for computing amount and timing of taxable gain or loss with respect to each of the options; and wherein the step of controlling the computer includes computing a tax liability or deduction for a purchaser of each of the options.

11. The method of claim 1, wherein the step of controlling the computer includes testing terms of the three options in determining that any one or more of the options is not a “constructive ownership transaction” under U.S. Internal Revenue Code section 1260.

12. The method of claim 2, wherein the method steps are predefined such that a purchaser of the options is not an owner of the investment portfolio, the reference portfolio, or the underlying for U.S. tax purposes.

13. The method claim 1, wherein the step of controlling includes generating output showing the three options as collateral for financing.

14. The method of claim 1, wherein the step of controlling includes generating output showing the three options as collateral in connection with zero coupon financing.

15. The method of claim 1, wherein the step of controlling includes generating output showing the three options as collateral in connection with non-recourse collateralized financing.

16. The method of claim 1, wherein the step of controlling includes generating output showing the three options as collateral in connection with prepaid zero coupon interest rate swap financing.

17. The method of claim 1, wherein said step of controlling the computer includes generating output showing the three options in connection with financing of a life insurance policy.

18. The method of claim 1, wherein the step of controlling includes generating output showing a portion of financing proceeds paying an initial premium of a life insurance policy and an amount of the financing proceeds to purchase the options.

19. The method of claim 17, wherein the step of controlling includes generating output showing a return of the reference portfolio sufficient to pay accrued cost of financing and an additional insurance premium of the insurance policy.

20. The method of claim 17, wherein the step of controlling includes generating output showing an initial insurance premium and a catch-up premium of a guaranteed no-lapse insurance policy as the insurance policy.

21. The method of claim 17, wherein the step of controlling includes generating output showing the financing and purchase of the insurance policy and the three options from a trust outside of an estate of a purchaser of the options.

22. The method claim 17, wherein the step of controlling includes generating output showing composition of an investment portfolio, said composition dictated by a purchaser of the options acting as an investment manager of the investment portfolio.

23. The method of claim 17, wherein the step of controlling includes generating output showing an amount of the life insurance policy substantially equal to unfunded non-qualified benefit liabilities of a purchaser.

24. The method of any of claim 23, wherein the step of generating output includes generating output showing the purchaser as a business entity with unfunded non-qualified benefit liabilities.

25. The method of claim 19, wherein the step of controlling includes generating output showing a purchaser of the options donating the life insurance policy to a charitable entity.

26. The method of claim 19, wherein the step of controlling includes generating output showing an amount donated by a purchaser of the options to a charitable entity after the purchaser redeems the three options and pays the accrued cost of the financing.

27. The method of claim 23, wherein the step of controlling includes generating output showing the financing and purchase of the insurance policy and the three options from the estate of the purchaser.

28. A computer system constructing a principal-protected investment indexed to a reference portfolio, the system including:
a system including a computer, an input device, an output device, and a program operating to direct the computer system to carry out the steps of:
entering into the computer a desired principal-protected amount, terms defining a reference portfolio call option indexed to performance of the reference portfolio, terms defining an index call option indexed to an underlying that is not being substantially similar to the reference portfolio, and terms defining an index put option indexed to the underlying; and
controlling said computer to use said principal-protected amount and said terms in generating output at the output device, the output including a combined cost of the three options substantially equal to the principal-protected amount, a combined expected payoff at expiration of the index call option and the index put option equal to the cost of the three options and a payoff at expiration of the reference portfolio call option substantially equal to increased value of the reference portfolio.

29. The system of claim 28, wherein the controlling includes indexing the reference portfolio to an investment portfolio.

30. The system of claim 29, wherein the controlling includes communicating identity of the investment portfolio to at least one potential counterparty computer; and further including the step of receiving said counterparty's cost to protect the principal-protected amount.

31. The system of claim 28, wherein the step of entering includes entering a notional amount of the reference portfolio call option, said notional amount being substantially equal to the principal-protected amount, a strike price for the reference portfolio call option substantially equal to the notional amount of the reference portfolio call option, an upfront cost for the reference portfolio call option, an expiration date, and a payout formula with no reference to interest cost, and entering a return of the reference portfolio; and wherein the controlling the computer includes calculating a payout value of the reference portfolio call option.

32. The system of claim 28, wherein the controlling includes communicating identity of the underlying to at least one potential counterparty computer.

33. The system of claim 28, wherein the step of entering includes entering a notional amount of the index call option, a strike price for the index call option, an upfront cost for the index call option, an expiration date, a payout formula, and a maximum payout, and entering a return of the underlying; and wherein the controlling the computer includes calculating a payout value of the index call option.

34. The system of claim 28, wherein the step of entering includes entering a notional amount of the index put option, a strike price for the put call option, an upfront cost for the index put option, an expiration date, a payout formula, and a maximum payout, and entering a return of the underlying; and wherein the controlling the computer includes calculating a payout value of the index put option.

35. The system of claim 28, wherein the step of entering includes entering an early redemption date and an early redemption amount for one of the index call option and the index put option.

36. The system of claim 28, wherein the controlling the computer includes testing that any combination of the options will not be a “conversion transaction” under U.S. Internal Revenue Code section 1258.

37. The system of claim 28, wherein the step of entering includes entering tax rates and at least one formula for computing amount and timing of taxable gain or loss with respect to each of the options; and wherein the controlling the computer includes computing a tax liability or deduction for a purchaser of each of the options.

38. The system of claim 28, wherein the controlling the computer includes testing terms of the three options in determining that any one or more of the options is not a “constructive ownership transaction” under U.S. Internal Revenue Code section 1260.

39. The system of claim 29, wherein the controlling includes processing predefined such that a purchaser of the options is not an owner of the investment portfolio, the reference portfolio, or the underlying for U.S. tax purposes.

40. The system of claim 28, wherein the output includes the three options as collateral for financing.

41. The system of claim 28, wherein the output includes the three options as collateral in connection with zero coupon financing.

42. The system of claim 28, wherein the output includes the three options as collateral in connection with non-recourse collateralized financing.

43. The system of claim 28, wherein the output includes the three options as collateral in connection with prepaid zero coupon interest rate swap financing.

44. The system of claim 28, wherein the output includes the three options in connection with financing of a life insurance policy.

45. The system of claim 28, wherein the output includes a portion of financing proceeds paying an initial premium of a life insurance policy and an amount of the financing proceeds to purchase the options.

46. The system of claim 44, wherein the output includes a return of the reference portfolio sufficient to pay accrued cost of financing and an additional insurance premium of the insurance policy.

47. The system of claim 44, wherein the output includes an initial insurance premium and a catch-up premium of a guaranteed no-lapse insurance policy as the insurance policy.

48. The system of claim 44, wherein the output includes the financing and purchase of the insurance policy and the three options from a trust outside of an estate of a purchaser of the options.

49. The system claim 44, wherein the output includes composition of an investment portfolio, said composition dictated by a purchaser of the options acting as an investment manager of the investment portfolio.

50. The system of claim 44, wherein the output includes an amount of the life insurance policy substantially equal to unfunded non-qualified benefit liabilities of a purchaser.

51. The system of any of claim 50, wherein the output includes the purchaser as a business entity with unfunded non-qualified benefit liabilities.

52. The system of claim 46, wherein the output includes a purchaser of the options donating the life insurance policy to a charitable entity.

53. The system of claim 46, wherein the output includes an amount donated by a purchaser of the options to a charitable entity after the purchaser redeems the three options and pays the accrued cost of the financing.

54. The system of claim 50, wherein the output includes the financing and purchase of the insurance policy and the three options from the estate of the purchaser.

55. A product produced by the process of claim 1.

56. The system of claim 28, the system including:
means for transmitting some of said terms to another computer.

57. The system of claim 28, the system including:
means for receiving some of said terms at another computer.

58. A computer program product having computer code stored thereon, which when run on a computer causes the computer to perform the steps of:
enabling entering into the computer a desired principal-protected amount, terms defining a reference portfolio call option indexed to performance of the reference portfolio, terms defining an index call option indexed to an underlying that is not being substantially similar to the reference portfolio, and terms defining an index put option indexed to the underlying; and
controlling said computer with a program to use said principal-protected amount and said terms to generate output including a combined cost of the three options substantially equal to the principal-protected amount, a combined expected payoff at expiration of the index call option and the index put option equal to the cost of the three options and a payoff at expiration of the reference portfolio call option substantially equal to increased value of the reference portfolio.
